(19) United States
(12) Patent Application Publication
(10) Pub. No.: US 2025/0280335 A1
(43) Pub. Date: Sep. 4, 2025

(54) CELL HANDOVER METHOD AND RELATED APPARATUS

(71) Applicant: HUAWEI TECHNOLOGIES CO., LTD., Shenzhen (CN)

(72) Inventors: Wenhui WANG, Shanghai (CN); Li SUN, Shenzhen (CN); Jianjun WU, Shenzhen (CN)

(21) Appl. No.: 19/209,507

(22) Filed: May 15, 2025

Related U.S. Application Data
(63) Continuation of application No. PCT/CN2022/132937, filed on Nov. 18, 2022.

(51) Int. Cl. H04W 36/00; H04W 36/08; H04W 36/30

(52) U.S. Cl. CPC H04W 36/0058; H04W 36/0072; H04W 36/08; H04W 36/30

(57) ABSTRACT

In one example method, a first network device sends configuration information of an uplink signal to a terminal device, where the uplink signal is allocated by a second network device and dedicated to a terminal device. The terminal device sends the uplink signal based on the configuration information. The second network device may perform measurement based on the received uplink signal obtain an uplink measurement result, and send the uplink measurement result to the first network device. The first network device may determine, based on the uplink measurement result, whether to hand over the terminal device to a cell associated with the second network device. If it is determined that the terminal device is to be handed over to the cell, the first network device may send a handover command message to the terminal device to command the terminal device to be handed over to the cell.

### CROSS-REFERENCE TO RELATED APPLICATIONS

This application is a continuation of International Application No. PCT/CN2022/132937, filed on Nov. 18, 2022, the disclosure of which is hereby incorporated by reference in its entirety.

### TECHNICAL FIELD

This disclosure relates to the field of communication technologies, and in particular, to a cell handover method and a related apparatus.

### BACKGROUND

Currently, a cell handover process is roughly divided into phases such as terminal device measurement, handover decision, handover preparation, and handover execution. In the terminal device measurement phase, a terminal device performs measurement on a serving cell and a neighbor cell based on measurement control information delivered by a source base station, and reports a measurement report (MR) to the source base station when a measurement result meets a measurement reporting condition. In the handover decision and preparation phases, the source base station performs handover decision based on the MR reported by the terminal device, and selects a target base station for the terminal device. Further, the source base station sends a handover request message to the target base station, and the target base station performs handover admission decision in response to the handover request message. If the terminal device is allowed to be handed over to a target cell, a handover request acknowledgment message is returned to the source base station. In the handover execution phase, the source base station delivers a handover command message to the terminal device. After receiving the handover command message, the terminal device synchronizes to the target base station based on the handover command message, initiates a random access procedure to the target base station, and sends a message 1 (MSG 1). After receiving the MSG 1, the target base station returns a message 2 (MSG 2) to the terminal device. After receiving the MSG 2, the terminal device sends a handover confirm message to the target base station. After receiving the handover confirm message, the target base station sends a terminal device resource release message to the source base station. In this case, handover of the terminal device is completed.

In the terminal device measurement phase, the terminal device performs measurement on the serving cell and the neighbor cell mainly in a manner of a synchronization signal and physical broadcast channel block (SS/PBCH block (SSB)) measurement. An SSB is designed by bundling a primary synchronization signal (PSS) or a secondary synchronization signal (SSS), a physical broadcast channel (PBCH), and a DMRS for a PBCH for simultaneous sending. The terminal device may implement downlink frequency and time synchronization with a cell by detecting the PSS or the SSS, and learn of a cell identifier (for example, a physical cell identifier (PCI)).

However, there is a problem that a cell handover process based on SSB measurement is vulnerable to attacks. For example, a pseudo base station forges information such as a downlink frequency, a PCI, and an SSB of the target base station, to induce the source base station and the target base station to select a cell of the target base station as a target cell in the handover decision and preparation phases, but the target base station actually does not meet a handover decision condition and/or a handover admission control condition. For example, the target base station is not adjacent to the source base station, and the terminal device does not enter coverage of the target base station; for another example, the pseudo base station forges an SSB having higher transmit power, and although the terminal device enters coverage of the target base station, a signal of a MSG 1 is poor and unstable; and so on. Consequently, a handover execution phase based on the target cell fails.

Therefore, how to avoid a forgery attack from the pseudo base station and increase a cell handover success rate is an urgent problem to be resolved.

### SUMMARY

This disclosure provides a cell handover method and a related apparatus, to avoid a forgery attack from a pseudo base station, and increase a cell handover success rate.

According to a first aspect, this disclosure provides a cell handover method. The method may be performed by a communication apparatus. The communication apparatus may be a communication device or a communication apparatus, for example, a chip, that can support the communication device in implementing a function needed in the method. For example, the communication apparatus is a first network device, a chip that is deployed in the first network device and that is configured to implement a function of the first network device, or another component configured to implement the function of the first network device. An example in which the first network device is used as an execution entity is used for description.

The method includes: The first network device receives configuration information of an uplink signal from a second network device, and sends the configuration information of the uplink signal to a terminal device, where the configuration information is configuration information allocated by the second network device to a terminal device dedicated uplink signal; the first network device receives an uplink measurement result from the second network device, where the uplink measurement result is obtained by the second network device through measurement based on the received uplink signal, and the uplink signal is sent by the terminal device based on the configuration information; and the first network device determines, based on the uplink measurement result, whether to hand over the terminal device to a cell of the second network device.

It can be learned that the configuration information of the uplink signal is dedicated to the terminal device, and may be delivered to the terminal device in a message having encryption and integrity protection information, so that a pseudo base station cannot learn of and forge the dedicated uplink signal, to avoid unnecessary handover caused by forging a downlink signal by the pseudo base station with high power, and increase a cell handover success rate. In addition, this disclosure can also reduce a series of other problems caused by a handover failure caused by pseudo base station forgery. For example, the terminal is attached to the pseudo base station, causing service interruption of the terminal. Alternatively, when a handover failure rate of an authorized target base station forged by the pseudo base station is excessively high and exceeds a threshold, a source base station adds the authorized target base station to a cell handover blocklist according to an automatic neighbor cell relation (ANR) feature rule. Even if the pseudo base station has been removed, the authorized target base station is not automatically removed from the handover blocklist, affecting availability of the authorized target base station. Alternatively, a handover failure rate from the terminal device to an authorized target base station increases, and a source base station automatically adjusts a handover threshold parameter based on a mobility robustness optimization (MRO) function, causing more handover failure problems. In addition, in the cell handover method, the uplink measurement result transmitted between the second network device and the first network device is transmitted through an Xn interface, to avoid overheads of newly added air interface time-frequency resources caused by transmitting the uplink measurement result.

In an optional implementation, if the first network device determines to hand over the terminal device to the cell, the first network device sends a handover command message to the terminal device, to command the terminal device to be handed over to the cell of the second network device.

In an optional implementation, the first network device further receives uplink synchronization information and uplink resource allocation information from the second network device. The uplink synchronization information is obtained by the second network device by performing uplink synchronization based on the received uplink signal, and the uplink resource allocation information indicates an uplink resource allocated by the second network device to the terminal device. The handover command message further includes the uplink synchronization information and the uplink resource allocation information. It can be learned that the first network device delivers the handover command message only after the terminal device performs uplink synchronization with the second network device, to reduce handover failures caused by an uplink synchronization failure. In addition, the handover command message including the uplink synchronization information and the uplink resource allocation information is a message having encryption and integrity protection information, so that uplink transmission security after cell handover is ensured. In addition, because the configuration information of the uplink signal can enable the terminal device to synchronize with the second network device by using the uplink signal, after being handed over to the cell, the terminal device may not need to send a random access message, for example, a message (MSG) 1 used for synchronization with the second network device. In addition, the first network device may send the uplink synchronization information and the uplink resource allocation information by using the handover command message. Therefore, after the terminal device is handed over to the cell, a MSG 2 used for obtaining the uplink synchronization information and the uplink resource allocation information may not need to be sent to the terminal device through an air interface, to avoid the overheads of the newly added air interface time-frequency resources, and enhance air interface transmission security of the uplink synchronization information and the uplink resource allocation information.

In an optional implementation, both the uplink measurement result and a downlink measurement result reported by the terminal device include quantized bits of an amplitude and a phase of a primary eigenvector of a channel between the second network device and the terminal device, or both include an oversampling group index of a space-frequency projection matrix of a channel between the second network device and the terminal device, an index of an angle-delay pair selected after space-frequency projection, and a quantized bit of a projection result of the selected angle-delay pair. In this way, the first network device may more accurately detect, based on information about uplink and downlink channels, whether there is a pseudo base station forging the second network device, to avoid unnecessary handover caused by the pseudo base station, and increase the cell handover success rate.

In another optional implementation, the uplink measurement result includes a beam index of an uplink optimal beam between the second network device and the terminal device and corresponding signal strength, corresponding signal quality, or a corresponding signal-to-noise ratio. In this way, the first network device determines, based on the information, whether to hand over the terminal device to the cell of the second network device.

In still another optional implementation, when an offset between signal quality of the cell and signal quality of a serving cell in the uplink measurement result is greater than a preset offset, or signal quality of a serving cell is lower than a first threshold and signal quality of the cell is higher than a second threshold, and/or when correlation between uplink and downlink measured channels obtained based on the uplink measurement result and the downlink measurement result reported by the terminal device meets a related condition, it is determined that the terminal device is to be handed over to the cell. Alternatively, when an offset between signal quality of the cell and signal quality of a serving cell in the uplink measurement result is less than or equal to a preset offset, signal quality of a serving cell is not lower than a first threshold, or signal quality of the cell is not higher than a second threshold, and/or when correlation between uplink and downlink measured channels obtained based on the uplink measurement result and the downlink measurement result reported by the terminal device does not meet a related condition, it is determined that the terminal device is not to be handed over to the cell. In this way, the cell handover success rate is increased by deciding the signal quality. In addition, whether there is a pseudo base station forging the second network device is detected by using the correlation between the uplink and downlink measured channels between the second network device and the terminal device, to avoid unnecessary handover caused by the pseudo base station, and increase the cell handover success rate.

In an optional implementation, before receiving the configuration information of the uplink signal from the second network device, the first network device sends a first request indication to the second network device, where the first request indication is used to request the second network device to allocate the configuration information of the dedicated uplink signal to the terminal device; and the first network device receives the configuration information of the uplink signal from the second network device. It can be learned that in this implementation, the first network device may request the configuration information of the uplink signal from the second network device.

In another optional implementation, before that the first network device receives the configuration information of the uplink signal from the second network device, the method further includes: The first network device receives the downlink measurement result from the terminal device, where the downlink measurement result is obtained by the terminal device by performing measurement on the serving cell and a neighbor cell based on downlink measurement control information; the first network device determines, based on the downlink measurement result, the cell to which the terminal device is allowed to be handed over and the second network device to which the cell belongs; and the first network device sends a second request indication to the second network device, where the second request indication is used to request to hand over the terminal device to the cell. It can be learned that in this implementation, the first network device may select, based on the downlink measurement result, the cell to which the terminal device is to be handed over, and after sending the second request indication to the second network device to which the cell belongs, receive the configuration information of the uplink signal from the second network device.

In still another optional implementation, before that the first network device receives the configuration information of the uplink signal from the second network device, the method further includes: The first network device receives downlink measurement feedback information from the terminal device, where the downlink measurement feedback information includes the downlink measurement result obtained by the terminal device by performing measurement on the serving cell and the neighbor cell based on downlink measurement control information, and information about the cell selected for handover; the first network device determines, based on the downlink measurement result, whether to allow the terminal device to be handed over to the cell; and if it is determined that the terminal device is allowed to be handed over to the cell, the first network device sends a second request indication to the second network device, where the second request indication is used to request to hand over the terminal device to the cell. It can be learned that in this implementation, the downlink measurement feedback information may carry the information about the cell to which the terminal device chooses to be handed over, so that information about each neighbor cell in the downlink measurement result can be reduced, to help reduce overheads of air interface time-frequency resources caused by the terminal by feeding back the downlink measurement result.

In still another optional implementation, the first network device may send the first request indication and the second request indication to the second network device, to request to hand over the terminal device to the second network device and request the configuration information of the uplink signal.

According to a second aspect, this disclosure further provides a cell handover method, corresponding to the cell handover method in the first aspect. The method may be performed by a communication apparatus. The communication apparatus may be a communication device or a communication apparatus, for example, a chip, that can support the communication device in implementing a function needed in the method. For example, the communication apparatus is a terminal device, a chip that is deployed in the terminal device and that is configured to implement a function of the terminal device, or another component configured to implement the function of the terminal device. An example in which the terminal device is used as an execution entity is used for description.

The method includes: The terminal device receives configuration information of an uplink signal from a first network device, where the configuration information is configuration information allocated by a second network device to a terminal device dedicated uplink signal, and an uplink measurement result of the uplink signal is used by the first network device to determine whether to hand over the terminal device to a cell of the second network device; and the terminal device sends the uplink signal based on the configuration information.

It can be learned that the configuration information of the uplink signal is dedicated to the terminal device, and the terminal device may obtain the configuration information from a message having encryption and integrity protection information, so that a pseudo base station cannot learn of and forge the dedicated uplink signal, to avoid unnecessary handover caused by forging a downlink signal by the pseudo base station with high power, and reduce impact of a quantity of handover failures caused by pseudo base station forgery on a handover failure. For example, the impact of the quantity of handover failures on the handover failure may include a problem that a forged authorized cell in an ANR is added to a blocklist and more handover failure problems caused by adjustment of a handover threshold parameter, and the like.

In an optional implementation, after the terminal device sends the uplink signal based on the configuration information, the terminal device may receive a handover command message from the first network device, where the handover command message indicates the terminal device to be handed over to the cell; and the terminal device performs cell handover based on the handover command message, and sends a handover confirm message to the second network device. It can be learned that in this implementation, the handover command message received by the terminal device is sent after the first network device determines, based on the uplink measurement result, handover to the cell of the second network device. In this way, the terminal device performs cell handover, to avoid unnecessary handover caused by the pseudo base station forgery, and increase a cell handover success rate.

In an optional implementation, the handover command message includes uplink synchronization information and uplink resource allocation information. The uplink synchronization information is obtained by the second network device by performing uplink synchronization based on the received uplink signal, and the uplink resource allocation information indicates an uplink resource allocated by the second network device to the terminal device. It can be learned that in this implementation, the terminal device receives the handover command message only after performing uplink synchronization with the second network device, to reduce handover failures caused by an uplink synchronization failure. In addition, the terminal device obtains the uplink synchronization information and the uplink resource allocation information by using the handover command message having encryption and integrity protection information, so that uplink transmission security after cell handover is ensured. In addition, because the terminal device is synchronized with the second network device by using the uplink signal, after being handed over to the cell, the terminal device may not need to send a random access message, for example, a message (MSG) 1 used for synchronization with the second network device. In addition, the terminal device obtains the uplink synchronization information and the uplink resource allocation information by using the handover command message. Therefore, after being handed over to the cell, the terminal device may not need to obtain, through an air interface, a MSG 2 that carries the uplink synchronization information and the uplink resource allocation information, to avoid overheads of newly added air interface time-frequency resources, and enhance air interface transmission security of the uplink synchronization information and the uplink resource allocation information.

In an optional implementation, before the terminal device receives the configuration information of the uplink signal from the first network device, the method further includes: The terminal device sends a downlink measurement result to the first network device. The downlink measurement result is obtained by the terminal device by performing measurement on a serving cell and a neighbor cell based on downlink measurement control information, and is used by the first network device to determine the cell to which the terminal device is allowed to be handed over and the second network device to which the cell belongs. It can be learned that in this implementation, the terminal device obtains the configuration information of the uplink signal after the first network device performs handover decision based on the downlink measurement result, so that the first network device determines, with reference to uplink and downlink measurement results, whether to hand over the terminal device to the cell, to increase the cell handover success rate.

In another optional implementation, before the terminal device receives the configuration information of the uplink signal from the first network device, the method further includes: The terminal device sends downlink measurement feedback information to the first network device, where the downlink measurement feedback information includes a downlink measurement result and information about the cell selected for handover. The downlink measurement result is obtained by the terminal device by performing measurement on a serving cell and a neighbor cell based on downlink measurement control information, and is used by the first network device to determine to allow the terminal device to be handed over to the cell, where a network device to which the cell belongs is the second network device. It can be learned that in this implementation, the downlink measurement feedback information may carry the information about the cell to which the terminal device chooses to be handed over, so that information about each neighbor cell in the downlink measurement result can be reduced, to help reduce overheads of air interface time-frequency resources caused by the terminal by feeding back the downlink measurement result.

In an optional implementation, the downlink measurement result includes quantized bits of an amplitude and a phase of a primary eigenvector of a channel between the second network device and the terminal device, or includes an oversampling group index of a space-frequency projection matrix of a channel between the second network device and the terminal device, an index of an angle-delay pair selected after space-frequency projection, and a quantized bit of a projection result of the selected angle-delay pair. In this way, the first network device may perform proper handover decision based on uplink and downlink channels between the terminal and the second network device, to increase the cell handover success rate.

According to a third aspect, this disclosure further provides a cell handover method, corresponding to the cell handover method in the first aspect and the second aspect. The method may be performed by a communication apparatus. The communication apparatus may be a communication device or a communication apparatus, for example, a chip, that can support the communication device in implementing a function needed in the method. For example, the communication apparatus is a second network device, a chip that is deployed in the second network device and that is configured to implement a function of the second network device, or another component configured to implement the function of the second network device. An example in which the second network device is used as an execution entity is used for description.

The method includes: The second network device sends configuration information of an uplink signal to a first network device, where the configuration information is configuration information allocated to a terminal device dedicated uplink signal, and an uplink measurement result of the uplink signal is used by the first network device to determine whether to hand over a terminal device to a cell of the second network device; the second network device performs measurement based on the received uplink signal, to obtain the uplink measurement result, where the uplink signal is sent by the terminal device based on the configuration information; and the second network device sends the uplink measurement result to the first network device.

It can be learned that the configuration information of the uplink signal is dedicated to the terminal device, and the second network device may send the configuration information in a message having encryption and integrity protection information, so that a pseudo base station cannot learn of and forge the dedicated uplink signal, to avoid unnecessary handover caused by forging a downlink signal by the pseudo base station with high power, and reduce impact of a quantity of handover failures caused by pseudo base station forgery on a handover failure. For example, the impact of the quantity of handover failures on the handover failure may include a problem that a cell in an ANR is added to a blocklist and more handover failure problems caused by adjustment of a handover threshold parameter, and the like. In addition, in the cell handover method, the uplink measurement result transmitted between the second network device and the first network device is transmitted through an Xn interface, to avoid overheads of newly added air interface time-frequency resources.

In an optional implementation, the method further includes: The second network device sends uplink synchronization information and uplink resource allocation information to the first network device. The uplink synchronization information is obtained by performing uplink synchronization based on the received uplink signal, and the uplink resource allocation information indicates an uplink resource allocated to the terminal device. It can be learned that in this implementation, the second network device may synchronize with the terminal device based on the uplink signal, to help reduce handover failures caused by an uplink synchronization failure. In addition, because the second network device synchronizes with the terminal device by using the uplink signal, after being handed over to the cell, the terminal device may not need to send a random access message, for example, a message (MSG) 1 used for synchronization with the second network device. In addition, the second network device may send the uplink synchronization information and the uplink resource allocation information in advance. Therefore, after being handed over to the cell, the terminal device may not need to obtain, through an air interface, a MSG 2 that carries the uplink synchronization information and the uplink resource allocation information, to reduce the overheads of the air interface time-frequency resources.

In an optional implementation, the uplink measurement result includes quantized bits of an amplitude and a phase of a primary eigenvector of a channel between the second network device and the terminal device, or includes an oversampling group index of a space-frequency projection matrix of a channel between the second network device and the terminal device, an index of an angle-delay pair selected after space-frequency projection, and a quantized bit of a projection result of the selected angle-delay pair; and/or the uplink measurement result includes a beam index of an uplink optimal beam between the second network device and the terminal device and corresponding signal strength, corresponding signal quality, or a corresponding signal-to-noise ratio. In this way, the first network device performs proper handover decision based on information about an uplink channel, to avoid unnecessary handover caused by a pseudo base station by forging a downlink signal, and further increase a cell handover success rate.

In an optional implementation, before the second network device sends the configuration information of the uplink signal to the first network device, the method further includes: The second network device receives a first request indication from the first network device, where the first request indication is used to request the second network device to allocate the configuration information of the dedicated uplink signal to the terminal device. It can be learned that in this implementation, the second network device may deliver the configuration information when the first network device requests the configuration information of the uplink signal.

In another optional implementation, the second network device receives a second request indication from the first network device, where the second request indication is used to request to hand over the terminal device to the cell; and if the second network device allows the terminal device to be handed over to the cell, the second network device performs the step of sending the configuration information of the uplink signal to the first network device. It can be learned that in this implementation, after receiving the second request indication from the first network device, the second network device sends the configuration information of the uplink signal when allowing the terminal device to be handed over to the cell.

In still another optional implementation, the second network device may receive the first request indication and the second request indication from the first network device, to request to hand over the terminal device to the second network device and request the configuration information of the uplink signal.

According to a fourth aspect, this disclosure provides a cell handover method. The method corresponds to the cell handover methods in the first aspect to the third aspect, and is described from a perspective of interaction between a first network device, a second network device, and a terminal device. For beneficial effects of this part, refer to related descriptions in the first aspect to the third aspect.

The method includes: The second network device sends configuration information of an uplink signal to the first network device, and correspondingly, the first network device receives the configuration information of the uplink signal. The first network device sends the configuration information of the uplink signal to the terminal device, where the configuration information is configuration information allocated by the second network device to a terminal device dedicated uplink signal, and an uplink measurement result of the uplink signal is used to determine whether to hand over the terminal device to a cell of the second network device. The terminal device sends the uplink signal based on the configuration information. The second network device performs measurement based on the received uplink signal, to obtain the uplink measurement result, and sends the uplink measurement result to the first network device, and correspondingly, the first network device receives the uplink measurement result, and determines, based on the uplink measurement result, whether to hand over the terminal device to the cell.

In an optional implementation, if the first network device determines to hand over the terminal device to the cell, the first network device sends a handover command message to the terminal device, where the handover command message indicates the terminal device to be handed over to the cell.

In an optional implementation, the second network device further sends uplink synchronization information and uplink resource allocation information to the first network device, where the uplink synchronization information is obtained by performing uplink synchronization based on the received uplink signal, and the uplink resource allocation information indicates an uplink resource allocated to the terminal device. Correspondingly, the first network device receives the uplink synchronization information and the uplink resource allocation information, and includes the uplink synchronization information and the uplink resource allocation information in the handover command message. Correspondingly, the terminal device receives the handover command message, performs cell handover based on the handover command message, and sends a handover confirm message to the second network device.

In an optional implementation, both the uplink measurement result and a downlink measurement result reported by the terminal device include quantized bits of an amplitude and a phase of a primary eigenvector of a channel between the second network device and the terminal device, or both include an oversampling group index of a space-frequency projection matrix of a channel between the second network device and the terminal device, an index of an angle-delay pair selected after space-frequency projection, and a quantized bit of a projection result of the selected angle-delay pair.

In an optional implementation, the uplink measurement result includes a beam index of an uplink optimal beam between the second network device and the terminal device and corresponding signal strength, corresponding signal quality, or a corresponding signal-to-noise ratio.

In an optional implementation, determining, based on the uplink measurement result, whether to hand over the terminal device to the cell includes: when an offset between signal quality of the cell and signal quality of a serving cell in the uplink measurement result is greater than a preset offset, or signal quality of a serving cell is lower than a first threshold and signal quality of the cell is higher than a second threshold, and/or when correlation between uplink and downlink measured channels obtained based on the uplink measurement result and the downlink measurement result reported by the terminal device meets a related condition, determining to hand over the terminal device to the cell; or when an offset between signal quality of the cell and signal quality of a serving cell in the uplink measurement result is less than or equal to a preset offset, signal quality of a serving cell is not lower than a first threshold, or signal quality of the cell is not higher than a second threshold, and/or when correlation between uplink and downlink measured channels obtained based on the uplink measurement result and the downlink measurement result reported by the terminal device does not meet a related condition, determining not to hand over the terminal device to the cell.

In an optional implementation, the first network device sends a first request indication to the second network device, where the first request indication is used to request the second network device to allocate the configuration information of the dedicated uplink signal to the terminal device. Correspondingly, the second network device receives the first request indication from the first network device, and performs the sending configuration information of an uplink signal to the first network device.

In another optional implementation, before the first network device receives the configuration information of the uplink signal from the second network device, the method further includes: The terminal device sends the downlink measurement result to the first network device, and correspondingly, the first network device receives the downlink measurement result from the terminal device, where the downlink measurement result is obtained by the terminal device by performing measurement on the serving cell and a neighbor cell based on downlink measurement control information. The first network device determines, based on the downlink measurement result, the cell to which the terminal device is allowed to be handed over and the second network device to which the cell belongs. The first network device sends a second request indication to the second network device, where the second request indication is used to request to hand over the terminal device to the cell. Correspondingly, the second network device receives the second request indication, and if the terminal device is allowed to be handed over to the cell, performs the step of sending the configuration information of the uplink signal to the first network device.

In still another optional implementation, before the first network device receives the configuration information of the uplink signal from the second network device, the method further includes: The terminal device sends downlink measurement feedback information to the first network device, where the downlink measurement feedback information includes the downlink measurement result and information about the cell selected for handover. The downlink measurement result is obtained by the terminal device by performing measurement on the serving cell and a neighbor cell based on the downlink measurement control information, and is used by the first network device to determine to allow the terminal device to be handed over to the cell, where a network device to which the cell belongs is the second network device. Correspondingly, the first network device receives the downlink measurement feedback information from the terminal device, and determines, based on the downlink measurement result, whether to allow the terminal device to be handed over to the cell. If it is determined that the terminal device is allowed to be handed over to the cell, the first network device sends a second request indication to the second network device, where the second request indication is used to request to hand over the terminal device to the cell. Correspondingly, the second network device receives the second request indication, and if the terminal device is allowed to be handed over to the cell, performs the step of sending the configuration information of the uplink signal to the first network device.

According to a fifth aspect, this disclosure provides a communication apparatus. The communication apparatus may be a network device, an apparatus in a network device, or an apparatus that can be used in combination with a network device. A function of the communication apparatus may be implemented by hardware, or may be implemented by executing corresponding software by hardware. The hardware or software includes one or more units or modules corresponding to the foregoing function. The unit or module may be software and/or hardware.

Optionally, the communication apparatus includes a processing unit and a communication unit, and performs a function of the first network device in the first aspect.

The communication unit is configured to: receive configuration information of an uplink signal from a second network device, where the configuration information is configuration information allocated by the second network device to a terminal device dedicated uplink signal, and an uplink measurement result of the uplink signal is used to determine whether to hand over a terminal device to a cell of the second network device; send the configuration information of the uplink signal to the terminal device; and receive the uplink measurement result from the second network device, where the uplink measurement result is obtained by the second network device through measurement based on the received uplink signal, and the uplink signal is sent by the terminal device based on the configuration information.

The processing unit is configured to: determine, based on the uplink measurement result, whether to hand over the terminal device to the cell.

The communication unit is further configured to: if the processing unit determines to hand over the terminal device to the cell, send a handover command message to the terminal device, where the handover command message indicates the terminal device to be handed over to the cell.

In an optional implementation, the communication unit is further configured to receive uplink synchronization information and uplink resource allocation information from the second network device. The uplink synchronization information is obtained by the second network device by performing uplink synchronization based on the received uplink signal, and the uplink resource allocation information indicates an uplink resource allocated by the second network device to the terminal device. The handover command message further includes the uplink synchronization information and the uplink resource allocation information.

In an optional implementation, that the processing unit determines, based on the uplink measurement result, whether to hand over the terminal device to the cell is specifically: When an offset between signal quality of the cell and signal quality of a serving cell in the uplink measurement result is greater than a preset offset, or signal quality of a serving cell is lower than a first threshold and signal quality of the cell is higher than a second threshold, and/or when correlation between uplink and downlink measured channels obtained based on the uplink measurement result and a downlink measurement result reported by the terminal device meets a related condition, the processing unit determines to hand over the terminal device to the cell; or when an offset between signal quality of the cell and signal quality of a serving cell in the uplink measurement result is less than or equal to a preset offset, signal quality of a serving cell is not lower than a first threshold, or signal quality of the cell is not higher than a second threshold, and/or when correlation between uplink and downlink measured channels obtained based on the uplink measurement result and a downlink measurement result reported by the terminal device does not meet a related condition, the processing unit determines not to hand over the terminal device to the cell.

In an optional implementation, before receiving the configuration information of the uplink signal from the second network device, the communication unit is further configured to send a first request indication to the second network device, where the first request indication is used to request the second network device to allocate the configuration information of the dedicated uplink signal to the terminal device.

In another optional implementation, before receiving the configuration information of the uplink signal from the second network device, the communication unit is further configured to receive the downlink measurement result from the terminal device, where the downlink measurement result is obtained by the terminal device by performing measurement on the serving cell and a neighbor cell based on downlink measurement control information. The processing unit is further configured to: determine, based on the downlink measurement result, the cell to which the terminal device is allowed to be handed over and the second network device to which the cell belongs. The communication unit is further configured to send a second request indication to the second network device, where the second request indication is used to request to hand over the terminal device to the cell.

In still another optional implementation, before receiving the configuration information of the uplink signal from the second network device, the communication unit is further configured to receive downlink measurement feedback information from the terminal device, where the downlink measurement feedback information includes the downlink measurement result obtained by the terminal device by performing measurement on the serving cell and a neighbor cell based on the downlink measurement control information, and information about the cell selected for handover. The processing unit is further configured to: determine, based on the downlink measurement result, whether to allow the terminal device to be handed over to the cell. The communication unit is further configured to: if the processing unit determines to allow the terminal device to be handed over to the cell, send a second request indication to the second network device, where the second request indication is used to request to hand over the terminal device to the cell.

For another optional implementation and beneficial effects of the communication apparatus, refer to the method and the beneficial effects in the first aspect.

Optionally, the communication apparatus performs a function of the second network device in the third aspect.

The communication unit is configured to send configuration information of an uplink signal to a first network device, where the configuration information is configuration information allocated to a terminal device dedicated uplink signal, and an uplink measurement result of the uplink signal is used by the first network device to determine whether to hand over a terminal device to a cell of a second network device.

The communication unit is further configured to perform measurement based on the received uplink signal, to obtain the uplink measurement result, where the uplink signal is sent by the terminal device based on the configuration information.

The communication unit is further configured to send the uplink measurement result to the first network device.

In an optional implementation, the communication unit is further configured to send uplink synchronization information and uplink resource allocation information to the first network device. The uplink synchronization information is obtained by performing uplink synchronization based on the received uplink signal, and the uplink resource allocation information indicates an uplink resource allocated to the terminal device.

In an optional implementation, before sending the configuration information of the uplink signal to the first network device, the communication unit is further configured to receive a first request indication from the first network device, where the first request indication is used to request the second network device to allocate the configuration information of the dedicated uplink signal to the terminal device.

In an optional implementation, the communication unit is further configured to: receive a second request indication from the first network device, where the second request indication is used to request to hand over the terminal device to the cell; and if the terminal device is allowed to be handed over to the cell, perform the operation of sending the configuration information of the uplink signal to the first network device.

For another optional implementation and beneficial effects of the communication apparatus, refer to the method and the beneficial effects in the third aspect.

According to a sixth aspect, this disclosure provides a communication apparatus. The communication apparatus may be a terminal device, an apparatus in a terminal device, or an apparatus that can be used in combination with a terminal device. The communication apparatus may alternatively be a chip system. A function of the communication apparatus may be implemented by hardware, or may be implemented by executing corresponding software by hardware. The hardware or software includes one or more units or modules corresponding to the foregoing function. The unit or module may be software and/or hardware.

The communication apparatus may perform the cell handover method in the second aspect, and the communication apparatus may include a communication unit.

The communication unit is configured to receive configuration information of an uplink signal from a first network device, where the configuration information is configuration information allocated by a second network device to a terminal device dedicated uplink signal, and an uplink measurement result of the uplink signal is used by the first network device to determine whether to hand over the terminal device to a cell of the second network device.

The communication unit is further configured to send the uplink signal based on the configuration information.

In an optional implementation, the communication unit is further configured to: receive a handover command message from the first network device, where the handover command message indicates the terminal device to be handed over to the cell; and perform cell handover based on the handover command message, and send a handover confirm message to the second network device.

In an optional implementation, the handover command message includes uplink synchronization information and uplink resource allocation information. The uplink synchronization information is obtained by the second network device by performing uplink synchronization based on the received uplink signal, and the uplink resource allocation information indicates an uplink resource allocated by the second network device to the terminal device.

In an optional implementation, before receiving the configuration information of the uplink signal from the first network device, the communication unit is further configured to send a downlink measurement result to the first network device. The downlink measurement result is obtained by the terminal device by performing measurement on a serving cell and a neighbor cell based on downlink measurement control information, and is used by the first network device to determine the cell to which the terminal device is to be handed over and the second network device to which the cell belongs.

In an optional implementation, before receiving the configuration information of the uplink signal from the first network device, the communication unit is further configured to send downlink measurement feedback information to the first network device, where the downlink measurement feedback information includes a downlink measurement result and information about the cell selected for handover. The downlink measurement result is obtained by the terminal device by performing measurement on a serving cell and a neighbor cell based on downlink measurement control information, and is used by the first network device to determine to allow the terminal device to be handed over to the cell, where a network device to which the cell belongs is the second network device.

For another optional implementation and beneficial effects of the communication apparatus, refer to the method and the beneficial effects in the second aspect.

Optionally, in the communication apparatus in the fifth aspect or the sixth aspect, the communication unit may be a transceiver, and the processing unit may be a processor. Optionally, the communication apparatus may further include a memory, configured to store instructions or a computer program, and the processor is configured to execute the computer program or the instructions stored in the memory, to enable the communication apparatus to perform any one of the first aspect to the third aspect or the optional implementations in any one of the first aspect to the third aspect.

According to a seventh aspect, this disclosure provides a communication apparatus. The communication apparatus may include a processor and an interface circuit. The interface circuit is configured to: receive a signal from a communication apparatus other than the communication apparatus and transmit the signal to the processor, or send a signal from the processor to a communication apparatus other than the communication apparatus. The processor is configured to implement the method in any one of the first aspect to the third aspect or the possible implementations of the first aspect to the third aspect by using a logic circuit or by executing code instructions.

According to an eighth aspect, this disclosure provides a computer-readable storage medium. The storage medium stores instructions, and when a computer program or the instructions are executed by a communication apparatus, the method shown in any one of the first aspect to the third aspect or the possible implementations of the first aspect to the third aspect is implemented.

According to a ninth aspect, this disclosure provides a computer program product including computer instructions. When a computer reads and executes the computer instructions, the computer is enabled to perform the method shown in any one of the first aspect to the third aspect or the possible implementations of the first aspect to the third aspect.

According to a tenth aspect, this disclosure provides a communication system, including at least one communication apparatus configured to perform the method in the first aspect, at least one communication apparatus configured to perform the method in the second aspect, and at least one communication apparatus configured to perform the method in the third aspect.

According to an eleventh aspect, this disclosure provides a circuit. The circuit is coupled to a memory, and the circuit is configured to perform the method shown in any one of the first aspect to the third aspect or the possible implementations of the first aspect to the third aspect. The circuit may include a chip circuit.

According to a twelfth aspect, this disclosure provides an apparatus. The apparatus includes modules or units configured to implement the method shown in any one of the first aspect to the third aspect or the possible implementations of the first aspect to the third aspect.

### BRIEF DESCRIPTION OF DRAWINGS

FIG. 1 is a schematic flowchart of a cell handover process;

FIG. 2 is a diagram of a pseudo base station attack scenario according to an embodiment of this disclosure;

FIG. 3 is a schematic flowchart of a cell handover process in a pseudo base station attack scenario according to an embodiment of this disclosure;

FIG. 4 is a schematic flowchart of a cell handover method according to an embodiment of this disclosure;

FIG. 5A and FIG. 5B are a schematic flowchart of another cell handover method according to an embodiment of this disclosure;

FIG. 6 is a schematic flowchart of still another cell handover method according to an embodiment of this disclosure;

FIG. 7 is a diagram of a structure of a communication apparatus according to an embodiment of this disclosure; and

FIG. 8 is a diagram of a structure of another communication apparatus according to an embodiment of this disclosure.

### DESCRIPTION OF EMBODIMENTS

In embodiments of this disclosure, a network device may also be referred to as an access network device. The access network device may be a device that provides radio access for a terminal device, and may include a radio access network (RAN) device and an access node (AN) device. The RAN device is mainly a wireless network device in a 3GPP network. The AN device may be an access network device not defined by 3GPP. The RAN device is mainly responsible for functions such as radio resource management, quality of service (QoS) management, and data compression and encryption on an air interface side. The RAN device may include base stations in various forms, for example, a macro base station, a micro base station (which may also be referred to as a small cell), a relay station, an access point, and a balloon station. In systems using different radio access technologies, names of devices having a base station function may be different. For example, in a long term evolution (LTE) system or in a 5th generation (5G), a 6th generation (6G), or even a 7th generation (7G) system, the network device may be referred to as a RAN or a next-generation node base station (gNB), an evolved NodeB (eNB or eNodeB), a network device controller (BSC), a network device transceiver station (BTS), a home network device (for example, a home evolved NodeB, or a home NodeB, HNB), a baseband unit (BBU), an access point (AP) in a wireless fidelity (Wi-Fi) system, a wireless relay node, a wireless backhaul node, a transmission and reception point (TRP), a transmission point (TP), or the like; or one or a group of (including a plurality of antenna panels) antenna panels of a network device in a 5G system, or may be a network node that forms a gNB or a transmission point, for example, a BBU, a distributed unit (DU), or a roadside unit (RSU) in vehicle to everything (V2X) or an intelligent driving scenario.

In some deployments, the gNB or the transmission point may include a central unit (CU), a DU, and the like. The gNB or the transmission point may further include a radio unit (RU). The CU implements a part of functions of the gNB or the transmission point, and the DU implements a part of functions of the gNB or the transmission point. For example, the CU implements functions of a radio resource control (RRC) layer and a packet data convergence protocol (PDCP) layer, and the DU implements functions of a radio link control (RLC) layer, a medium access control or media access control (MAC) layer, and a physical (PHY) layer. Information at the RRC layer finally becomes information at the physical layer or is converted from information at the physical layer. Therefore, in this architecture, it may be considered that higher layer signaling such as RRC layer signaling or PDCP layer signaling is sent by the DU or is sent by the DU and the RU. It can be understood that the network device may be a CU node, a DU node, or a device including a CU node and a DU node. Optionally, the network device may alternatively be an auxiliary communication device, for example, a satellite.

In embodiments of this disclosure, the terminal device is a device having a wireless transceiver function, and may be deployed on land, including an indoor device or an outdoor device, a handheld device, a wearable device, or a vehicle-mounted device, may be deployed on water (for example, on a ship), or may be deployed in the air (for example, on an airplane, a balloon, or a satellite). The terminal may be a mobile phone, a tablet computer (e.g. a Pad), a computer having a wireless transceiver function, a virtual reality (VR) terminal device, an augmented reality (AR) terminal device, a wireless terminal in industrial control, a vehicle-mounted terminal device, a wireless terminal in self-driving, a wireless terminal in telemedicine, a wireless terminal in a smart grid, a wireless terminal in transportation safety, a wireless terminal in a smart city, a wireless terminal in a smart home, a wearable terminal device, or the like. The terminal sometimes may also be referred to as a terminal device, user equipment (UE), an access terminal device, a vehicle-mounted terminal, an industrial control terminal, a LUE unit, a LUE station, a mobile station, a remote station, a remote terminal device, a mobile device, a LUE agent, a LUE apparatus, or the like. The terminal may alternatively be fixed or mobile.

This disclosure may be applicable to communication systems with various radio access technologies (RAT). For example, the communication system may be an LTE communication system, a 5G (or referred to as new radio (NR)) communication system, or a transition system between an LTE communication system and a 5G communication system. The transition system may also be referred to as a 4.5G communication system, or certainly may be a future communication system, for example, a 6th generation (6G) or even 7th generation (7G) system. The network architecture and the service scenario described in embodiments of this disclosure are intended to describe the technical solutions in embodiments of this disclosure more clearly, and do not constitute a limitation on the technical solutions provided in embodiments of this disclosure. A person of ordinary skill in the art may learn that with evolution of communication network architectures and emergence of new service scenarios, the technical solutions provided in embodiments of this disclosure are also applicable to similar technical problems.

To clearly describe the technical solutions in embodiments of this disclosure, terms such as “first” and “second” are used in embodiments of this disclosure to distinguish between same items or similar items that have basically same functions or purposes. A person skilled in the art may understand that the terms such as “first” and “second” do not limit a quantity or an execution sequence, and the terms such as “first” and “second” do not indicate a definite difference. The term “and/or” describes an association relationship for describing associated objects and indicates that three relationships may exist. For example, A and/or B may indicate the following three cases: Only A exists, both A and B exist, and only B exists. The character “/” generally indicates that the associated objects are in an “or” relationship.

For ease of understanding of this disclosure, the following describes some concepts in embodiments of this disclosure.

### 1. Cell Handover

Cell handover may be referred to as mobile handover or mobility management in a connected state, and is a process in which a terminal device working in a mobile communication system continuously moves during use, and when the terminal device moves from coverage of one cell to coverage of another cell, communication of the terminal device cannot be interrupted, in other words, a physical channel is maintained and a serving cell is changed. The terminal device is in a radio resource control (RRC) connected state, and the terminal device has two states including a synchronized state and an out-of-synchronization state. Cell handover is a process in which when the terminal device is in the synchronized state, the terminal device reports a location and an identifier of the terminal device to a network side, and the network side enables, according to various policies, the terminal device to maintain the physical channel (in other words, communication cannot be interrupted) and change the serving cell of the terminal device.

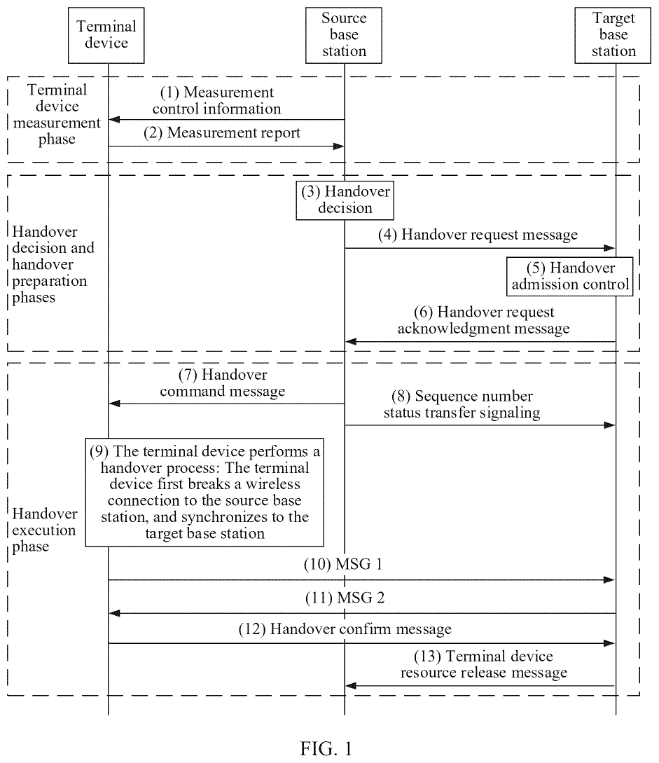

The cell handover process is roughly divided into phases such as terminal device measurement, handover decision, handover preparation, and handover execution. For example, as shown in FIG. 1, in the terminal device measurement phase:
(1) A source base station sends measurement control information to the terminal device.
(2) The terminal device performs measurement on a serving cell and a neighbor cell based on the measurement control information, and when a measurement result meets a measurement reporting condition, the terminal device reports a measurement report (MR) to the source base station.

In the handover decision and handover preparation phases:
(3) The source base station performs handover decision based on the MR reported by the terminal device and radio resource management information of the source base station, and selects a target base station for the terminal device.
(4) The source base station sends a handover request message to the target base station.
(5) The target base station performs handover admission decision in response to the handover request message.
(6) If the target base station allows the terminal device to be handed over to a target cell, the target base station returns a handover request acknowledgment (Handover Request ACK) message to the source base station.

In the handover execution phase:
(7) The source base station delivers a handover command message to the terminal device.
(8) The source base station sends sequence number status transfer (SN Status Transfer) signaling to the target base station, where the SN status transfer signaling may transfer uplink packet data convergence protocol (PDCP) sequence number (SN) receiving status information and downlink PDCP SN sending status information of a user plane data radio bearer (DRB).
(9) After receiving the handover command message, the terminal device synchronizes to the target base station based on parameter information carried in the handover command message.
(10) The terminal device sends a message 1 (MSG 1) to the target base station, to request to access the target cell.
(11) After receiving the MSG 1, the target base station returns, to the terminal device, a message 2 (MSG 2) that carries an uplink synchronization result and uplink scheduling information.
(12) After receiving the MSG 2, the terminal device sends a handover confirm message to the target base station.
(13) After receiving the handover confirm message, the target base station sends a terminal device resource release message to the source base station. In this case, handover of the terminal device is completed.

In this disclosure, cell handover relates to a handover procedure in a same core network (that is, neither an access and mobility management function (AMF) nor a user plane function (UPF) involved before and after handover changes). A core network (for example, a 5G core network) does not need to join the handover preparation and execution phases. For example, handover preparation messages such as the handover request message and the handover request ACK message shown in FIG. 1 are directly exchanged between base stations, for example, exchanged through a communication interface (e.g. an Xn interface) between the base stations. Therefore, cell handover described in this disclosure may also be referred to as Xn interface handover.

In this disclosure, cell handover may include intra-frequency handover and inter-frequency handover. In intra-frequency handover, a center frequency and a subcarrier spacing (SCS) of a source cell are the same as those of a target cell that is to be handed over to. In inter-frequency handover, at least one of the center frequency or the subcarrier spacing of the source cell is different from that of the target cell that is to be handed over to.

### 2. Downlink Measurement Result and Uplink Measurement Result

The downlink measurement result is obtained by the terminal device by performing measurement on the serving cell or the neighbor cell based on measurement control information (referred to as downlink measurement control information in this specification) of a downlink channel or signal delivered by the base station. When the downlink measurement result meets the measurement reporting condition, the terminal device reports the downlink measurement result to the serving cell. Optionally, the downlink measurement result may be reported to the base station by using the measurement report. Based on different definitions of measurement objects of the terminal device, measurement may include: SSB-based intra-frequency measurement, where to be specific, a center frequency and an SCS of an SSB that is used for measurement and that is of the neighbor cell are the same as those of an SSB of the serving cell; and SSB-based inter-frequency measurement, where to be specific, at least one of the center frequency and the SCS of the SSB that is used for measurement and that is of the neighbor cell is different from that of the SSB of the serving cell.

The terminal device sends an uplink channel or signal based on measurement control information (which may be referred to as uplink measurement control information) that is of the uplink channel or signal and that is delivered by the base station, and the network side performs measurement based on the received uplink signal or channel, to obtain the uplink measurement result. For example, in this disclosure, a second network device allocates configuration information to a terminal device dedicated uplink signal, the terminal device may send the uplink signal based on the configuration information, and the second network device performs measurement based on the received uplink signal, to obtain the uplink measurement result.

In the terminal device measurement phase, the terminal device performs measurement on the serving cell and the neighbor cell mainly in a synchronization signal and physical broadcast channel block (SSB) measurement-based manner or a channel state information-reference signal (CSI-RS) measurement-based manner. An SSB is designed by bundling a primary synchronization signal (PSS) or a secondary synchronization signal (SSS), a physical broadcast channel (PBCH), and a DMRS for a PBCH for simultaneous sending. The terminal device may implement downlink frequency and time synchronization with a cell by detecting the PSS or the SSS, and learn of a cell identifier (for example, a PCI). If the CSI-RS measurement-based manner is used, a network device to which each neighbor cell belongs needs to allocate a specified CSI-RS resource to the terminal device. However, there are an excessively large quantity of online terminal devices in a same cell, and the specified CSI-RS resource cannot be allocated to all the terminal devices. If the SSB measurement-based manner is used, there is a problem of vulnerability to attacks. For example, a pseudo base station forges information such as a downlink frequency, a PCI, and an SSB of the target base station, to induce the source base station and the target base station to select a cell of the target base station as the target cell in the handover decision and preparation phases, but the target base station actually does not meet a handover decision condition and/or a handover admission control condition. For example, the target base station is not adjacent to the source base station, and the terminal device does not enter coverage of the target base station; for another example, the pseudo base station forges an SSB having higher transmit power, and although the terminal device enters coverage of the target base station, a signal of the MSG 1 is poor and unstable; and so on. Consequently, a handover execution phase based on the target cell fails.

For example, a pseudo base station C replays a broadcast message (for example, an SSB, a master information block (MIB), or a system information block (SIB) 1) of an authorized base station B with high power. Consequently, a handover failure rate of the authorized base station B increases. For example, the pseudo base station first searches for a PCI of a cell having strongest signal strength in a live network and changes a PCI of the pseudo base station to the PCI. After the PCI of the cell having strongest signal strength in the live network changes, the pseudo base station can update the PCI of the pseudo base station after a period of time and forge a PCI and a frequency of an authorized cell having a strongest signal strength. In this way, the terminal device measures that SSB signal quality of the pseudo base station C is higher than that of the serving cell and meets a measurement control condition, and reports the measurement report. The source base station performs handover decision, selects the authorized base station B forged by the pseudo base station as the target base station, and allows the terminal device to be handed over to a cell of the target base station B. However, after receiving an HO command, the terminal device starts random access and sends a Msg 1. Because the terminal device may not be in coverage of a target cell B, the target cell B cannot receive the Msg 1, and the target base station B cannot complete random access with UE. Consequently, entire handover fails. Similarly, in this process, handover success rates of all cells near a geographical area in which the pseudo base station is located suddenly decrease. For example, a handover success rate related to the cell of the forged target base station B is low. The pseudo base station is found through troubleshooting by a worker. However, this type of problem needs to be resolved by disabling the pseudo base station, which is difficult to coordinate. Alternatively, a temporary solution is to change a type of a neighbor cell that has a handover relationship with the pseudo base station to “forbid handover”. After the change, the handover success rate can be restored. However, consequently, an actual authorized base station forged by the pseudo base station is unavailable.

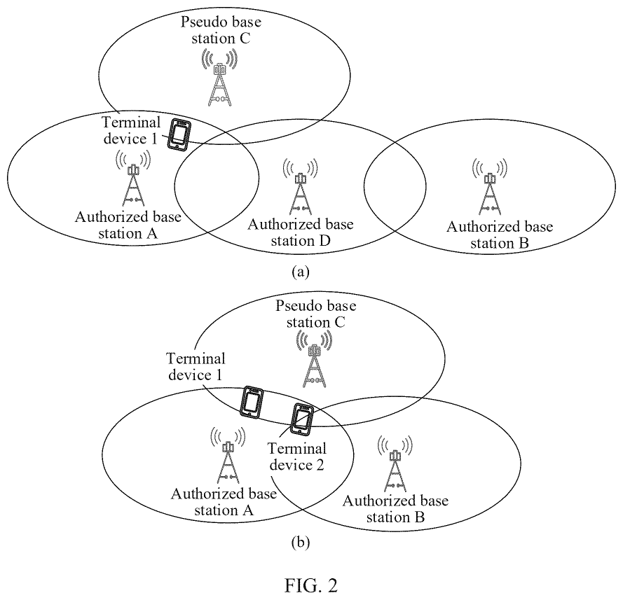

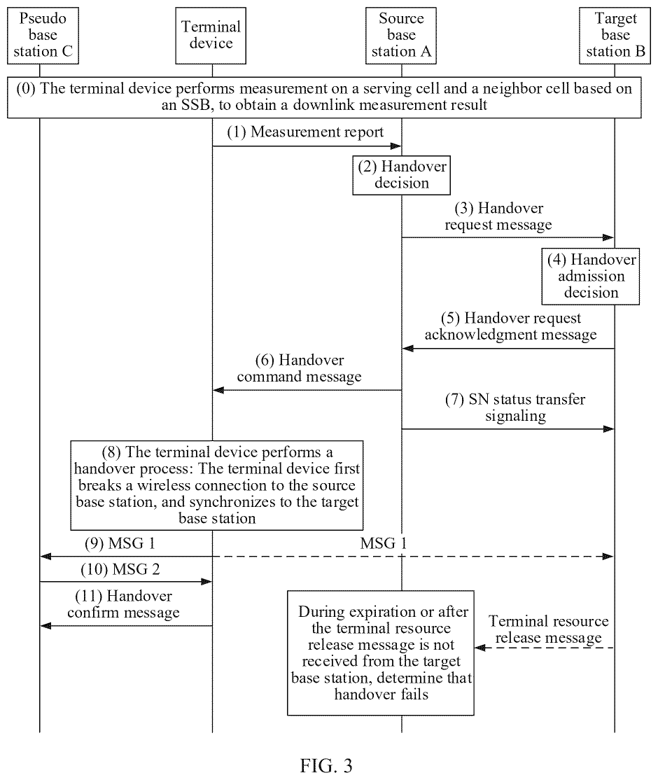

FIG. 2 is a diagram of a pseudo base station attack scenario. In a remote-end forgery scenario shown in (a) of FIG. 2, an authorized base station A and an authorized base station B are not geographically adjacent to each other. For example, there is an authorized base station D between the authorized base station A and the authorized base station B, and a pseudo base station C forges the authorized base station B. It is assumed that a source base station is the authorized base station A, a PCI of the source base station A is 100, and PCIs of the authorized base station B and the pseudo base station C are 105. A possible handover attack procedure for a case in which a terminal device moves to overlapping coverage between the source base station A and the pseudo base station C but is not located in coverage of the authorized base station B is shown in FIG. 3.
(0) The terminal device performs measurement on a serving cell and a neighbor cell based on an SSB, to obtain a downlink measurement result.
(1) When the downlink measurement result meets a measurement reporting condition, the terminal device reports an MR to the source base station A, where the MR includes signal quality of an SSB that is of the authorized base station B and that is forged by the pseudo base station C.
(2) The source base station A performs handover decision based on the measurement result reported by the terminal device, selects a cell that is learned of and whose PCI is 105 as a target cell, and searches a neighbor cell relation table (NCRT) for the target base station B whose PCI is 105.
(3) The source base station A sends a handover request message to the target base station B.
(4) After receiving the handover request message, the target base station B performs handover admission control.
(5) If the terminal device is allowed to be handed over to the target cell, a handover request ACK message is sent to the source base station A.
(6) After receiving the handover request ACK message, the source base station A sends a handover command message to the terminal device.
(7) The source base station A sends SN status transfer signaling to the target base station B.
(8) The terminal device is separated from the source base station A in response to the handover command message, and is synchronized to the pseudo base station C based on a received broadcast message (including an SSB, a MIB, or a SIB 1).
(9) The terminal device sends a non-contention-based random access MSG 1.
(10) The pseudo base station C sends a MSG 2 in response to the MSG 1, where the MSG 2 includes uplink synchronization information and uplink resource allocation information.
(11) The terminal device receives the MSG 2, and sends a handover confirm message. However, because the terminal device is not in coverage of the target base station B, the target base station B cannot receive the MSG 1 or the handover confirm message sent by the terminal device. Therefore, it is considered that handover fails, and a terminal device resource release message (also referred to as a terminal device context release message) is not sent to the source base station A. Correspondingly, because the source base station does not receive the terminal device resource release message, it is considered that current handover fails.

For another example, in a near-end forgery scenario shown in (b) of FIG. 2, the authorized base station A and the authorized base station B are geographically adjacent, and the pseudo base station C forges the authorized base station B. Coverage of the pseudo base station C is different from that of the authorized base station B, and transmit power of the pseudo base station C is higher. When a terminal device 1 moves from the authorized base station A to the overlapping coverage between the authorized base station A and the pseudo base station C, but does not enter the coverage of the authorized base station B, the pseudo base station C forges an SSB of the valid base station B. Consequently, the source base station A performs handover decision, and selects the authorized base station B as the target base station. Because the terminal device 1 actually does not enter the coverage of the target base station B, a handover attack procedure shown in FIG. 3 is caused, and the terminal device fails to be handed over to the target base station B.

For still another example, in a near-end forgery scenario shown in (b) of FIG. 2, when a terminal device 2 moves to overlapping coverage of the authorized base station A, the authorized base station B, and the pseudo base station C, the source base station A performs handover decision, and selects the authorized base station B as the target base station. In this case, although the authorized base station B may receive the MSG 1 and send the MSG 2 to the terminal device, subsequent random access fails because, for example, access performance of an uplink Msg 1 is poor and unstable, or the MSG 2 is overwritten and tampered with by the pseudo base station C in a random access procedure. Consequently, the terminal device still fails to be handed over to the target base station B.

Therefore, how to avoid a forgery attack from the pseudo base station and increase a cell handover success rate is an urgent problem to be resolved.

In a cell handover method provided in this disclosure, a first network device may send configuration information of an uplink signal to the terminal device, where the configuration information is configuration information allocated by a second network device to a terminal device dedicated uplink signal, and an uplink measurement result of the uplink signal is used to determine whether to hand over the terminal device to a cell of the second network device. The first network device determines, based on the uplink measurement result of the uplink signal, to hand over the terminal device to the cell, and then sends a handover command message to the terminal device, to indicate the terminal device to hand over to the cell. It can be learned that the configuration information of the uplink signal is dedicated to the terminal device, and may be delivered to the terminal device in a message having encryption and integrity protection information, so that the pseudo base station cannot learn of and forge the dedicated uplink signal, to avoid unnecessary handover caused by forging a downlink signal by the pseudo base station with high power, and increase the cell handover success rate.

The following describes the cell handover method provided in this disclosure with reference to the accompanying drawings.

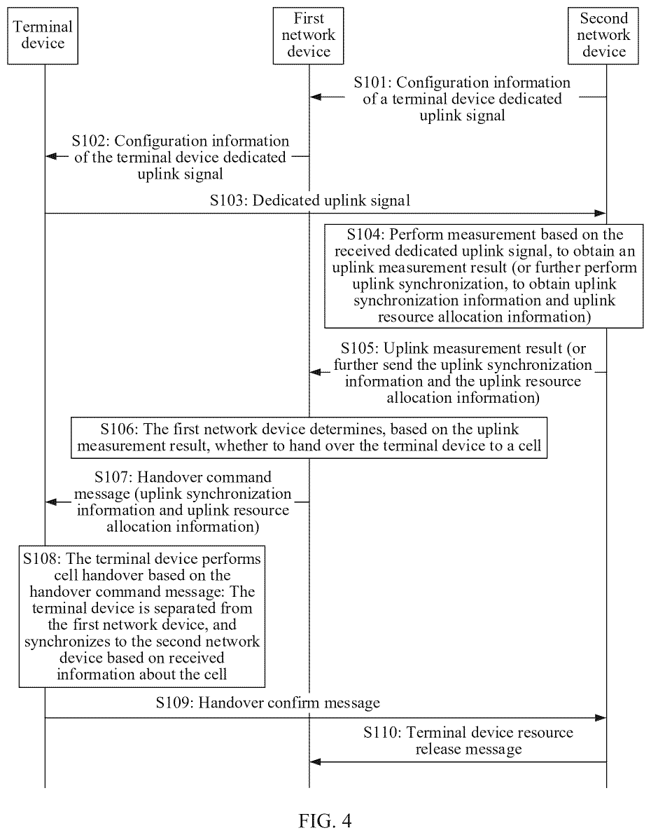

FIG. 4 is a schematic flowchart of a cell handover method according to an embodiment of this disclosure. The cell handover method shown in FIG. 4 is described in a manner of interaction between a first network device, a second network device, and a terminal device. It is assumed that the first network device is a network device to which a serving cell currently accessed by the terminal device belongs, the second network device is a network device to which a cell to which the terminal device is to be handed over belongs. Optionally, the cell that is to be handed over to may be selected by the first network device by performing handover decision based on a downlink measurement result reported by the terminal device, or may be selected by the terminal device based on a downlink measurement result. Optionally, there may be at least one cell that is to be handed over to. For each cell that is to be handed over to, the cell handover method in this embodiment of this disclosure may be performed, so that the first network device finally determines, from the cell that is to be handed over to, the cell to which the terminal device is to be handed over. As shown in FIG. 4, the cell handover method includes but is not limited to the following steps.

S101: The second network device sends configuration information of a terminal device dedicated uplink signal to the first network device, and correspondingly, the first network device receives the configuration information of the dedicated uplink signal.

The configuration information is configuration information allocated by the second network device to the terminal device dedicated uplink signal, and an uplink measurement result of the uplink signal is used by the first network device to determine whether to hand over the terminal device to a cell of the second network device. Optionally, the configuration information may also be referred to as configuration information of a handover dedicated uplink signal. Correspondingly, the uplink signal may be referred to as a handover dedicated uplink signal. The configuration information of the terminal device dedicated (UE specific) uplink signal is allocated by the second network device, and is dedicated to the terminal device. The second network device does not allocate the configuration information to another terminal device, so that the second network device can accurately obtain channel state information of an uplink channel between the second network device and the terminal device based on the uplink signal.

Optionally, before the second network device sends the configuration information of the dedicated uplink signal to the first network device, the first network device may send a first request indication to the second network device, where the first request indication is used to request the second network device to allocate the configuration information of the dedicated uplink signal to the terminal device.

S102: The first network device sends the configuration information of the terminal device dedicated uplink signal to the terminal device, and correspondingly, the terminal device receives the configuration information of dedicated uplink signal.

S103: The terminal device sends the dedicated uplink signal based on the configuration information.

Optionally, the configuration information of the dedicated uplink signal may be included in a radio resource control (RRC) message or an RRC reconfiguration message, and is sent by the first network device to the terminal device. For example, an information element may be newly added to the RRC message or the RRC reconfiguration message, to indicate the configuration information of the dedicated uplink signal. Optionally, the configuration information may include information such as a sequence generation parameter, a time-frequency domain resource parameter, and a transmit power parameter of the dedicated uplink signal. Optionally, if the uplink signal is a dedicated physical random access channel (PRACH) uplink synchronization signal, the configuration information may be an RRC information element (for example, a random access channel-dedicated configuration (RACH-ConfigDedicated)) configured for a PRACH.

S104: The second network device performs measurement based on the received dedicated uplink signal, to obtain the uplink measurement result.

S105: The second network device sends the uplink measurement result to the first network device, and correspondingly, the first network device receives the uplink measurement result.

S106: The first network device determines, based on the uplink measurement result, whether to hand over the terminal device to the cell.

In an optional implementation, the uplink measurement result may include a beam index of an uplink optimal beam between the second network device and the terminal device and corresponding signal strength (for example, reference signal received power (RSRP)), corresponding signal quality (for example, reference signal received quality (RSRQ)), or a corresponding signal-to-noise ratio (for example, a signal to interference plus noise ratio (SINR)). In this way, the first network device determines, based on the information, whether to hand over the terminal device to the cell of the second network device. It can be learned that, in this implementation, decision is performed based on a status of the uplink optimal beam, to help increase a cell handover success rate. The uplink optimal beam is a beam having highest received energy, for example, having largest or highest RSRQ, RSRP, or SINR, in a plurality of beams used by the second network device to receive the dedicated uplink signal.

For example, when the first network device determines, based on the uplink measurement result, whether to hand over the terminal device to the cell, an intra-frequency A3 event reporting condition and an inter-frequency A5 event reporting condition may still be used. For example, the intra-frequency A3 event reporting condition is still used. If an offset between signal quality of the cell and signal quality of a serving cell is greater than a preset offset, it is determined that the terminal device is to be handed over to the cell. Otherwise, if an offset between signal quality of the cell and signal quality of a serving cell is less than or equal to a preset offset, it is determined that the terminal device is not to be handed over to the cell. For another example, the inter-frequency A5 event reporting condition is still used. If signal quality of a serving cell is lower than a first threshold, and signal quality of the cell is higher than a second threshold, it is determined that the terminal device is to be handed over to the cell. If signal quality of a serving cell is not lower than a first threshold, and signal quality of the cell is not higher than a second threshold, it is determined that the terminal device is not to be handed over to the cell.

In another optional implementation, when channel correlation that is between uplink and downlink measurement and that is obtained by the first network device based on the uplink measurement result and a downlink measurement result reported by the terminal device meets a related condition, it is determined that the terminal device is to be handed over to the cell. When channel correlation that is between uplink and downlink measurement and that is obtained based on the uplink measurement result and a downlink measurement result reported by the terminal device does not meet a related condition, it is determined that the terminal device is not to be handed over to the cell. In this implementation, the first network device may further detect, by using the correlation between uplink and downlink measurement, whether there is a pseudo base station forging the second network device, to avoid unnecessary handover caused by the pseudo base station, and increase the cell handover success rate.

In a case, the downlink measurement result reported by the terminal device may alternatively carry a beam index of a downlink optimal beam and corresponding signal strength, corresponding signal quality, or a corresponding signal-to-noise ratio. For example, the downlink optimal beam may be an optimal downlink SSB beam of the serving cell and the neighbor cell, and the corresponding signal strength, the corresponding signal quality, or the corresponding signal-to-noise ratio may be RSRP, RSRQ, and an SINR. The related condition that can be met by correlation between uplink and downlink measured channels may include one or more of the following: The beam index of the uplink optimal beam is the same as a beam index of the downlink optimal beam, a difference between the signal strength corresponding to the uplink optimal beam and the signal strength corresponding to the downlink optimal beam is less than a preset value, an offset between the signal quality corresponding to the uplink optimal beam and the signal quality corresponding to the downlink optimal beam is less than a preset offset, and an offset between the signal-to-noise ratio corresponding to the uplink optimal beam and the signal-to-noise ratio corresponding to the downlink optimal beam is less than a preset offset.

For example, the beam index of the uplink optimal beam is the same as the beam index of the downlink optimal beam. The terminal device receives a plurality of downlink SSBs sent by the second network device, where an SSB index 3 has highest RSRP. It is assumed that the SSB index 3 corresponds to an SSB transmit beam 3. The terminal device notifies the first network device of an SSB index having highest received RSRP of the second network device. The second network device receives the dedicated uplink signal sent by the terminal device, and the second network device performs receive beam domain processing on the uplink signal by using a plurality of SSB transmit beams. It is assumed that received energy of the uplink signal is highest in the beam index 3. The second network device notifies the first network device of an optimal receive beam index (that is, the beam index 3) of the uplink signal by using the uplink measurement result. In this way, if the first network device determines that optimal beam indexes of uplink and downlink measurement between the terminal device and the second network device are the same, the first network device may perform handover decision, that is, determine to hand over the terminal device to the cell of the second network device.

In another case, both the uplink measurement result and the downlink measurement result reported by the terminal device include quantized bits of an amplitude and a phase of a primary eigenvector of a channel between the second network device and the terminal device.

A method for calculating quantized bits of an amplitude and a phase of a primary eigenvector of a channel in the downlink measurement result includes the following steps.
(1) The terminal device calculates an equivalent channel Ĥⁱ based on an optimal beam of an SSB:

$${\hat{H}}^{i} = {H}^{i} * {W}_{SSB} \qquad ( 1 )$$

W_{SSB} is the optimal beam of the SSB, and Hⁱ is an air interface channel H at a moment i.
(2) The terminal device calculates a channel measurement average value Ĥ of a specific subband or a full band based on an equivalent channel at the moment i.
(3) The terminal device calculates a covariance matrix Rₕₕ based on the channel measurement average value Ĥ:

$${R}_{h h} = {\hat{H}}^{H} * \hat{H} \qquad ( 2 )$$

Ĥ^{H} is a transpose of the channel measurement average value Ĥ.
(4) The terminal device obtains an eigenvector matrix V based on the covariance matrix Rₕₕ according to the following formula:

$$EVD ( {R}_{h h} ) = V Λ {V}^{H} \qquad ( 3 )$$

EVD represents an algorithm formula for decomposing an eigenvalue, and a first column of V is the primary eigenvector V₀.
(5) The terminal device separately performs N-bit quantization on an amplitude and a phase of each element of V₀, to obtain the quantized bits of the amplitude and the phase of the primary eigenvector, where N is a positive integer and is configured by a higher layer.

Therefore, the downlink measurement result reported by the terminal device may include the quantized bits of the amplitude and the phase of the primary eigenvector of the downlink channel. Correspondingly, the second network device may determine, based on the optimal beam of the uplink signal, quantized bits of an amplitude and a phase of a primary eigenvector of an uplink channel through the foregoing step (1) to step (5).

Correspondingly, the correlation between the uplink and downlink measured channels may be obtained through calculation based on the primary eigenvector of the uplink channel and the primary eigenvector of the downlink channel. For example, if V_{UL} is used to represent the primary eigenvector of the uplink channel, and V_{DL} is used to represent the primary eigenvector of the downlink channel, the channel correlation Corr between uplink and downlink measurement is:

$$Corr = \frac{\vert {V}_{DL}^{H} * {V}_{UL} \vert}{\vert {V}_{DL}^{H} \vert * \vert {V}_{UL} \vert} \qquad ( 4 )$$

0.0≤Corr≤1.0. A smaller value of Corr indicates poorer channel correlation between the uplink and downlink channels, and a higher probability that pseudo base station forgery exists.

In this case, the related condition that can be met by the correlation between the uplink and downlink measured channels may be that a channel correlation threshold Corr_Thread=0.9. In other words, the first network device determines to hand over the terminal device to the cell of the second network device only when the channel correlation is greater than Corr_Thread. In addition, this case may be applied to a system having high reciprocity, for example, a time division duplex (TDD) system.

In still another case, both the uplink measurement result and the downlink measurement result reported by the terminal device include an oversampling group index of a space-frequency projection matrix of a channel between the second network device and the terminal device, an index of an angle-delay pair selected after space-frequency projection, and a quantized bit of a projection result of the selected angle-delay pair.

An oversampling group index of a space-frequency projection matrix of a channel, an index of an angle-delay pair selected after space-frequency projection, and a quantized bit of a projection result of the selected angle-delay pair in the downlink measurement result may be obtained through but not limited to the following steps.
(1) The terminal device separately calculates primary eigenvectors of a plurality of subbands according to the foregoing formulas (1) to (3), where a primary eigenvector of a single subband is

$${v}_{0} = [ \begin{matrix}{v}_{0 , V} \\ {v}_{0 , H}\end{matrix} ] ∈ {C}^{{N}_{p} * 1} ,$$

v_{0,V} and v_{0,H} respectively represent components of v₀ in a vertical polarization direction and a horizontal polarization direction, Nₚ is a quantity of ports of the network device, and C is complex vector space.
(2) The terminal device combines the primary eigenvectors of the plurality of subbands, to obtain a space-frequency matrix H=[v⁰ . . . v^{SB_num_WB-1}], where SB_num_WB is a quantity of subbands.
(3) For the space-frequency matrix H, the terminal device separately traverses base vectors of different space-domain and frequency-domain oversampling groups to perform space-frequency dual-domain compression projection, as shown in the following formula (5):

$$\hat{H} = {( {B}_{space}^{( {q}_{1} , {q}_{2} )} )}^{H} * H * {B}_{freq}^{( {q}_{3} )} \qquad ( 5 )$$

Ĥ represents a channel measurement average value, B_{space}^{(q}^{₁}^{,q}^{₂}⁾ is from a space-domain base vector oversampling group, there are O₁O₂ space-domain oversampling groups, q₁=0, 1, . . . , O₁−1, q₂=0, 1, . . . , O₂−1, and each group includes

$${C}^{\frac{{N}_{p}}{2} * \frac{{N}_{p}}{2}} .$$

-dimensional space-domain base vectors, that is, B_{space}^{(q}^{₁}^{,q}^{₂}⁾∈

$$Np / 2 \frac{{N}_{p}}{2} * 1 .$$

B_{freq}^{(q}^{₃}⁾ is from a frequency-domain base vector oversampling group, there are O₃ frequency-domain oversampling groups, q₃=0, 1, . . . , O₃−1, and each group includes N₃=SB_num_WB SB_num_WBx1-dimensional frequency-domain base vectors, that is, B_{freq}^{(q}^{₃}⁾∈C^{N}^{₃}*^{N}^{₃}. A space-domain base matrix B_{space}^{(q}^{₁}^{,q}^{₂}⁾ and a frequency-domain base matrix B_{freq}^{(q}^{₃}⁾ are obtained after a corresponding oversampling group index (q₁, q₂, q₃) is determined based on a principle that a sum of energy of the angle-delay pair after projection is the maximum.
(4) The terminal device selects a base row and column index (C_{L}^{s},C_{K}^{f}) of a space-frequency projection matrix of an angle and a delay that have high energy after space-frequency projection, that is, an index of an angle-delay pair that is selected after space-frequency projection and that has high energy. The angle-delay pair having high energy may be an angle-delay pair whose energy is greater than a specific threshold, and the threshold may be predefined or notified by using signaling.
(5) A corresponding projection result is obtained based on the base row and column index (C_{L}^{s},C_{K}^{f}) of the space-frequency projection matrix to form a combination coefficient matrix Cₗ, and an amplitude and a phase of an element in the combination coefficient matrix are quantized to obtain a quantized amplitude and a quantized phase of the element in the combination coefficient matrix Cₗ, that is, quantized bits of the projection result of the selected angle-delay pair. s represents a space domain, f represents a frequency domain, L represents a quantity of indexes of an angle having high energy, and K represents a quantity of indexes of a delay having high energy.

In this way, the downlink measurement result may include the oversampling group index of the space-frequency projection matrix of the downlink channel between the terminal device and the second network device, the index of the angle-delay pair selected after space-frequency projection, and the quantized bit of the projection result of the selected angle-delay pair. Correspondingly, the second network device may also calculate the uplink measurement result based on the received uplink signal through the method described in the foregoing step (1) to step (5). The uplink measurement result may also include an oversampling group index of a space-frequency projection matrix of an uplink channel between the terminal device and the second network device, an index of an angle-delay pair selected after space-frequency projection, and a quantized bit of a projection result of the selected angle-delay pair.

Optionally, the first network device separately performs weight reconstruction based on the information about the uplink channel and the downlink channel, to separately obtain eigenvector matrices V_{UL} and V_{DL} of the uplink channel and the downlink channel. Further, the first network device may calculate the channel correlation according to the foregoing formula (4). Correspondingly, the related condition that can be met by the correlation between the uplink and downlink measured channels may be that the channel correlation threshold Corr_Thread=0.8. In other words, the first network device determines to hand over the terminal to the cell of the second network device only when the channel correlation Corr is greater than Corr_Thread. Otherwise, when the channel correlation Corr is less than or equal to Corr_Thread, the first network device determines not to hand over the terminal to the cell of the second network device. Optionally, in this case, a requirement for reciprocity between uplink and downlink channels is low. For example, this case may be applied to frequency division duplex (FDD) deployment, TDD deployment (with no complete reciprocity), or multi-station (multi-TRP) transmission.

Optionally, the first network device may compare the oversampling group index of the space-frequency projection matrix of the uplink channel and the index of the angle-delay pair selected after space-frequency projection with the oversampling group index of the space-frequency projection matrix of the downlink channel and the index of the angle-delay pair selected after space-frequency projection. If the oversampling group index of the space-frequency projection matrix of the uplink channel and the index of the angle-delay pair selected after space-frequency projection are partially or completely the same as the oversampling group index of the space-frequency projection matrix of the downlink channel and the index of the angle-delay pair selected after space-frequency projection, it may be determined that the correlation between the uplink and downlink measured channels meets the related condition, and then it is determined that the terminal device is to be handed over to the cell of the second network device. Otherwise, it may be determined that the correlation between the uplink and downlink measured channels does not meet the related condition, and then it is determined that the terminal device is not to be handed over to the cell of the second network device.

Optionally, the first network device may compare the oversampling group index of the space-frequency projection matrix of the uplink channel and the index of the angle-delay pair selected after space-frequency projection with the oversampling group index of the space-frequency projection matrix of the downlink channel and the index of the angle-delay pair selected after space-frequency projection, and calculate the channel correlation by using the eigenvector matrix V_{UL} of the uplink channel and the eigenvector matrix V_{DL} of the downlink channel. If the oversampling group index of the space-frequency projection matrix of the uplink channel and the index of the angle-delay pair selected after space-frequency projection are partially or completely the same as the oversampling group index of the space-frequency projection matrix of the downlink channel and the index of the angle-delay pair selected after space-frequency projection, and the calculated channel correlation is greater than the channel correlation threshold, it is determined that the correlation between the uplink and downlink measured channels meets the related condition, and it may be determined that the terminal is to be handed over to the cell of the second network device. Otherwise, if the oversampling group index of the space-frequency projection matrix of the uplink channel and the index of the angle-delay pair selected after space-frequency projection are completely different from the oversampling group index of the space-frequency projection matrix of the downlink channel and the index of the angle-delay pair selected after space-frequency projection, or the calculated channel correlation is less than or equal to the channel correlation threshold, it is determined that the correlation between the uplink and downlink measured channels does not meet the related condition, and then it is determined that the terminal device is not to be handed over to the cell of the second network device.

In still another optional implementation, when the offset between the signal quality of the cell and the signal quality of the serving cell in the uplink measurement result is greater than the preset offset, or the signal quality of the serving cell is lower than the first threshold and the signal quality of the cell is higher than the second threshold, and when the correlation between the uplink and downlink measured channels obtained based on the uplink measurement result and the downlink measurement result reported by the terminal device meets the related condition, it is determined that the terminal device is to be handed over to the cell. When the offset between the signal quality of the cell and the signal quality of the serving cell in the uplink measurement result is less than or equal to the preset offset, the signal quality of the serving cell is not lower than the first threshold, the signal quality of the cell is not higher than the second threshold, or when the correlation between the uplink and downlink measured channels obtained based on the uplink measurement result and the downlink measurement result reported by the terminal device does not meet the related condition, it is determined that the terminal device is not to be handed over to the cell. In this way, the cell handover success rate is increased by deciding the signal quality. In addition, whether there is a pseudo base station forging the second network device is detected by using the correlation between uplink and downlink measured channels, to avoid unnecessary handover caused by the pseudo base station, and increase the cell handover success rate. Specifically, for the channel correlation and the condition that needs to be met by the channel correlation in this implementation, refer to related content described in the foregoing embodiments.

It can be learned that, in the cell handover method, the configuration information of the uplink signal is dedicated to the terminal device, and may be delivered to the terminal device in a message having encryption and integrity protection information, so that the pseudo base station cannot learn of and forge the dedicated uplink signal, to avoid unnecessary handover caused by forging a downlink signal by the pseudo base station with high power, and increase the cell handover success rate. In addition, in this disclosure, impact of a quantity of handover failures caused by pseudo base station forgery on a handover failure can also be reduced. For example, the impact of the quantity of handover failures on the handover failure may include a problem that a cell in an ANR is added to a blocklist and more handover failure problems caused by adjustment of a handover threshold parameter and the like. In addition, in the cell handover method, the uplink measurement result transmitted between the second network device and the first network device is transmitted through an Xn interface, to avoid overheads of newly added air interface time-frequency resources. In addition, in the method, an optional implementation in which the first network device determines whether to hand over the terminal device to the cell of the second network device helps further increase the cell handover success rate.

In an optional implementation, in addition to the foregoing steps S101 to S106, in the cell handover method shown in FIG. 4, if it is determined that the terminal device is to be handed over to the cell, the cell handover method may further include related operations in the handover execution phase described in step (7) to step (13) shown in FIG. 1. If it is determined that the terminal device is not to be handed over to the cell, the first network device may send a handover cancel message to the second network device.

In another optional implementation, in addition to the foregoing steps S101 to S106, in the cell handover method shown in FIG. 4, if it is determined that the terminal device is to be handed over to the cell, the cell handover method may further include steps S107 to S110 shown in FIG. 4. If it is determined that the terminal device is not to be handed over to the cell, the first network device may send a handover cancel message to the second network device.

S107: The first network device sends a handover command message to the terminal device, and correspondingly, the terminal device receives the handover command message, where the handover command message includes uplink synchronization information and uplink resource allocation information.

In this implementation, the configuration information of the dedicated uplink signal may be configuration information of a MSG 1 in a random access procedure initiated by the terminal device. For example, the configuration information may include information such as a PRACH sequence generation parameter, a time-frequency domain resource parameter, and a transmit power parameter. Optionally, if the uplink signal is a dedicated PRACH uplink synchronization signal, the configuration information may be an RRC information element RACH-ConfigDedicated configured for a PRACH. In step S103, the uplink signal sent by the terminal device based on the configuration information may be the MSG 1. In this way, in step S104, in addition to performing measurement based on the received uplink signal to obtain the uplink measurement result, the second network device may further perform uplink synchronization with the terminal device based on the received uplink signal, to obtain the uplink synchronization information, and allocate the uplink resource allocation information to the terminal device. Optionally, the uplink synchronization information may be an uplink timing advance (TA) value, and the uplink resource allocation information indicates an uplink resource allocated by the second network device to the terminal device. In step S105, in addition to sending the uplink measurement result to the first network device, the second network device may further send the uplink synchronization information and the uplink resource allocation information.

Optionally, the uplink measurement result, the uplink synchronization information, and the uplink resource allocation information may be carried in a handover measurement feedback message, and sent by the second network device to the first network device through the Xn interface.

S108: The terminal device performs cell handover based on the handover command message.

That the terminal device performs cell handover based on the handover command message may include: The terminal device is separated from the first network device, and is synchronized to the second network device based on received information about the cell. Because the terminal device has obtained the uplink synchronization information and the uplink resource allocation information by using the handover command message, the terminal device does not need to send a MSG 2 as shown in FIG. 1, to reduce signaling exchange, and further reduce overheads of air interface time-frequency resources.

S109: The terminal device sends a handover confirm message to the second network device, and correspondingly, the second network device receives the handover confirm message.

S110: The second network device sends a terminal device resource release message to the first network device, and correspondingly, the first network device receives the terminal device resource release message. Further, the first network device may release context information of the terminal device. In this case, the terminal device completes cell handover.

It can be learned that, in this implementation, the first network device delivers the handover command message only after the terminal device performs uplink synchronization with the second network device, to reduce handover failures caused by an uplink synchronization failure. In addition, the uplink synchronization information and the uplink resource allocation information are sent to the terminal device by using the handover command message. Because the handover command message is an RRC reconfiguration message having encryption and integrity protection information, uplink transmission security after cell handover is ensured. In addition, because the terminal device synchronizes with the second network device by using the dedicated uplink signal, after being handed over to the cell, the terminal device may not need to send a random access message, for example, the message (MSG) 1 used for synchronization with the second network device. In addition, the first network device may send the uplink synchronization information and the uplink resource allocation information by using the handover command message. Therefore, after the terminal device is handed over to the cell, the MSG 2 used for obtaining the uplink synchronization information and the uplink resource allocation information may not need to be sent to the terminal device through an air interface, to reduce the overheads of the air interface time-frequency resources.

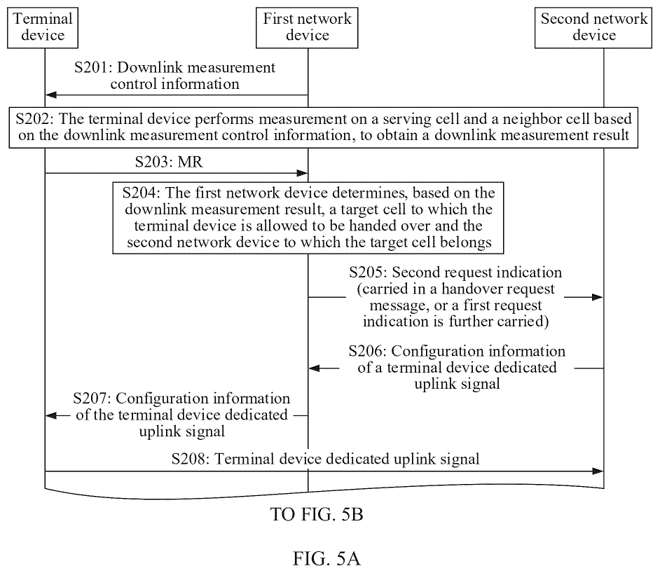

FIG. 5A and FIG. 5B are a schematic flowchart of another cell handover method according to an embodiment of this disclosure. A difference between the cell handover method shown in FIG. 5A and FIG. 5B and the cell handover method in FIG. 4 lies in that in the cell handover method shown in FIG. 5A and FIG. 5B, a cell of a second network device is a target cell that is selected by a first network device by performing handover decision based on a downlink measurement result reported by a terminal device and to which the terminal device is allowed to be handed over. Correspondingly, the second network device is a target network device (for example, a base station corresponding to a PCI of the target cell found in an NCRT) found by the first network device based on information about the target cell. As shown in FIG. 5A and FIG. 5B, the cell handover method may include but is not limited to the following steps.

S201: The first network device sends downlink measurement control information to the terminal device, and correspondingly, the terminal device receives the downlink measurement control information.

S202: The terminal device performs measurement on a serving cell and a neighbor cell based on the downlink measurement control information, to obtain a downlink measurement result.

S203: The terminal device reports an MR to the first network device when the downlink measurement result meets a reporting condition, where the MR includes the downlink measurement result; and correspondingly, the first network device receives the MR.

As described above, the downlink measurement result may include a beam index of a downlink optimal beam and corresponding signal strength, corresponding signal quality, or a corresponding signal-to-noise ratio. In a case, the reporting condition met by the downlink measurement result may be an intra-frequency A3 event reporting condition, to be specific, an offset between signal quality of the neighbor cell and signal quality of the serving cell is greater than a preset offset. In this case, it may be determined that the downlink measurement result meets the reporting condition. Otherwise, if an offset between signal quality of the neighbor cell and signal quality of the serving cell is less than or equal to a preset offset, it may be determined that the downlink measurement result does not meet the reporting condition. In another case, the reporting condition met by the downlink measurement result may be an inter-frequency A5 event reporting condition, to be specific, signal quality of the serving cell is lower than a first threshold, and signal quality of the neighbor cell is higher than a second threshold, and it may be determined that the downlink measurement result meets the reporting condition. If signal quality of the serving cell is not lower than a first threshold, and signal quality of the neighbor cell is not higher than a second threshold, it is determined that the downlink measurement result does not meet the reporting condition.

Optionally, in addition to the intra-frequency A3 event reporting condition and the inter-frequency A5 event reporting condition, the reporting condition may be set by the first network device in the downlink measurement control information.

S204: The first network device determines, based on the downlink measurement result, the target cell to which the terminal device is allowed to be handed over and the second network device to which the target cell belongs.

In this disclosure, as described above, in addition to the related information about an optimal beam of each neighbor cell, downlink channel information may be further newly added to the downlink measurement result, for example, quantized bits of an amplitude and a phase of a primary eigenvector of a channel between the network device to which each neighbor cell belongs as described above and the terminal device, and/or an oversampling group index of a space-frequency projection matrix of the channel, an index of an angle-delay pair selected after space-frequency projection, and a quantized bit of a projection result of the selected angle-delay pair are newly added. Correspondingly, the first network device may perform handover decision based on one or more pieces of information in the downlink measurement result, and select the target cell and the second network device to which the target cell belongs.

S205: The first network device sends a second request indication to the second network device, where the second request indication is used to request to hand over the terminal device to the target cell; and correspondingly, the second network device receives the second request indication.

Optionally, the second request indication may be carried in the handover request message in FIG. 1. Optionally, the handover request message may further include a first request indication, and the first request indication is used to request the configuration information of the dedicated uplink signal described above.

S206: If the terminal device is allowed to be handed over to the target cell, the second network device sends the configuration information of the dedicated uplink signal to the first network device; and correspondingly, the first network device receives the configuration information of the dedicated uplink signal.

The second network device may determine, through handover admission decision in step (5) in FIG. 1, whether to allow the terminal device to be handed over to the target cell. For example, the second network device determines, based on a load status of the second network device and a quality of service (QoS) requirement of a service, whether to allow the terminal device to access the target cell. If the terminal device is allowed to access the target cell, a dedicated admission resource is allocated to the terminal device, so that the terminal device may access the target cell based on the admission resource, for example, the admission resource may be a resource for sending the dedicated uplink signal. Optionally, the configuration information of the dedicated uplink signal may be carried in the handover request ACK message in FIG. 1.

S207: The first network device sends the configuration information of the dedicated uplink signal to the terminal device, and correspondingly, the terminal device receives the configuration information of the dedicated uplink signal.

S208: The terminal device sends the dedicated uplink signal based on the configuration information.

S209: The second network device performs measurement based on the received dedicated uplink signal, to obtain an uplink measurement result.

S210: The second network device sends the uplink measurement result to the first network device, and correspondingly, the first network device receives the uplink measurement result.

S211: The first network device determines, based on the uplink measurement result, whether to hand over the terminal device to the target cell.

For steps S206 to S211, refer to the optional implementations in the foregoing steps S101 to S106. In an optional implementation in step S211, the first network device determines, based on the uplink measurement result or based on the uplink measurement result and the downlink measurement result, whether to hand over the terminal device to the target cell, where the downlink measurement result is obtained in step S202.

Optionally, handover decision in step S204 may be referred to as primary decision of handover decision, and determining whether to hand over the terminal device to the target cell in step S211 may be referred to as secondary decision of handover decision. A difference between the primary decision and the secondary decision lies in that the primary decision is handover decision based on the downlink measurement result, and the secondary decision is handover decision based on the uplink measurement result or handover decision based on the uplink measurement result and the downlink measurement result. For details, refer to related content described above.

Optionally, in this embodiment, after the first network device determines to hand over the terminal device to the target cell, in an optional implementation, as described above, step (7) to step (13) shown in FIG. 1 may be performed. In another optional implementation, as described above, steps S107 to S110 shown in FIG. 4 may be performed. In FIG. 5A and FIG. 5B, an example in which steps S107 to S110 shown in FIG. 4 are performed is used. Steps S107 to S110 shown in FIG. 4 correspond to steps S212 to S215 in FIG. 5A and FIG. 5B.

It can be learned that, in the cell handover method shown in FIG. 5A and FIG. 5B, after allowing the terminal device to be handed over to the target cell, the first network device performs handover decision again based on the uplink measurement result obtained through measurement by the second network device. Because the uplink measurement result is obtained through measurement based on the terminal device dedicated uplink signal, a case in which the uplink measurement result is forged by a pseudo base station can be avoided, to improve security of cell handover. In addition, in an optional implementation, a handover command message may be sent after the second network device performs uplink synchronization with the terminal device based on the uplink signal, to reduce handover failures caused by an uplink synchronization failure. In addition, the uplink measurement result obtained by the first network device is transmitted by the second network device through an interface between network devices, to avoid newly added air interface time-frequency overheads. In an optional implementation, the handover command message carries uplink synchronization information and uplink resource allocation information, to ensure uplink transmission security after handover. In an optional implementation, the first network device may perform decision by using correlation between uplink and downlink channels in the secondary decision. Because the pseudo base station can only forge the downlink channel, but cannot forge the uplink channel, whether pseudo base station forgery exists between the second network device and the terminal device can be detected more accurately.

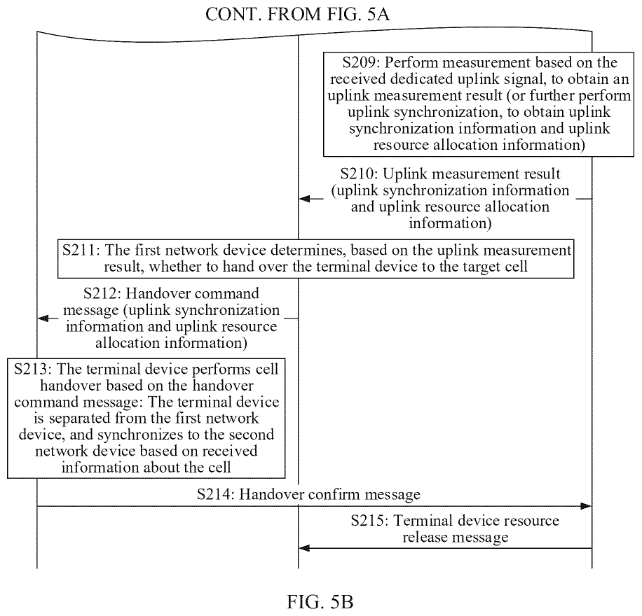

FIG. 6 is a schematic flowchart of another cell handover method according to an embodiment of this disclosure. A difference between the cell handover method shown in FIG. 6 and the cell handover method in FIG. 5A and FIG. 5B lies in that in the cell handover method shown in FIG. 6, a cell of a second network device is selected by a terminal device, for example, a target cell that is selected from a neighbor cell based on a downlink measurement result and to which the terminal device requests to be handed over. Optionally, the target cell to which the terminal device requests to be handed over may be carried in an MR sent by the terminal device to a first network device, or may be carried in a handover request message sent by the terminal device to the first network device. Because the terminal device may report, to the first network device, the target cell to which the terminal device requests to be handed over, the MR or the handover request message may carry measurement results of a serving cell and the target cell, to reduce measurement results that are of neighbor cells and that need to be carried, so as to reduce overheads of needed air interface time-frequency resources. Specifically, as shown in FIG. 6, the cell handover method may include steps S301 to S314. S301, S302, and S304 to S314 correspond to steps S205 to S215 in FIG. 5A and FIG. 5B. For details, refer to related content in FIG. 5A and FIG. 5B. S303: The terminal device sends the MR or the handover request message to the first network device, where the MR or the handover request message includes the target cell selected by the terminal device.

It can be learned that, in this implementation, downlink measurement feedback information may carry information about the cell to which the terminal device chooses to be handed over, so that information about each neighbor cell in the downlink measurement result can be reduced, to help reduce overheads of air interface time-frequency resources caused by the terminal by feeding back the downlink measurement result.

It may be understood that, to implement the functions in the foregoing embodiments, the network device and the terminal device include corresponding hardware structures and/or software modules for performing the functions. A person skilled in the art should be easily aware that, in this disclosure, the units and method steps in the examples described with reference to embodiments disclosed in this disclosure can be implemented by hardware or a combination of hardware and computer software. Whether a function is performed by hardware or hardware driven by computer software depends on particular application scenarios and design constraint conditions of the technical solutions.

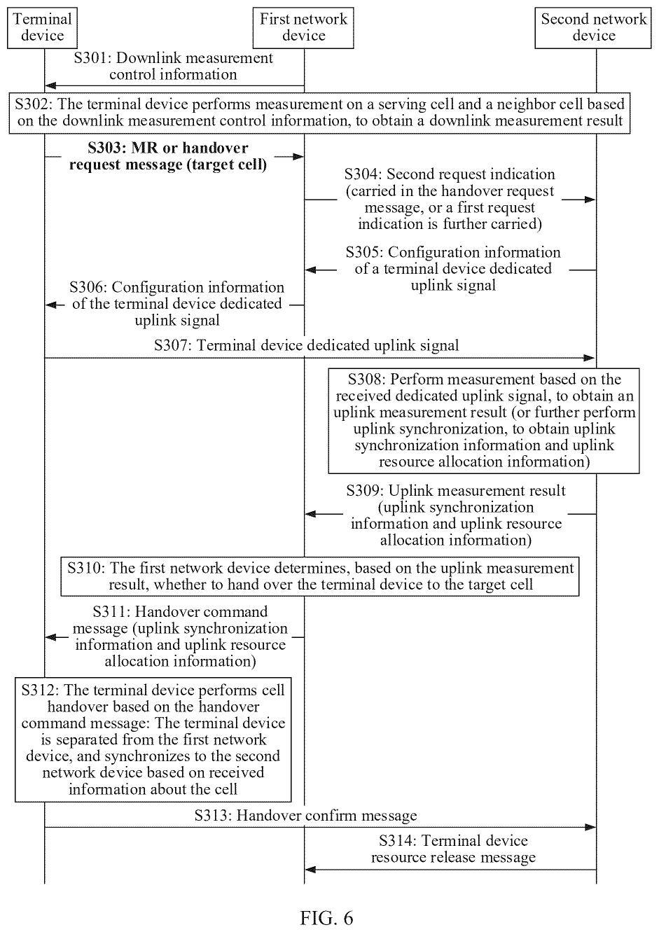

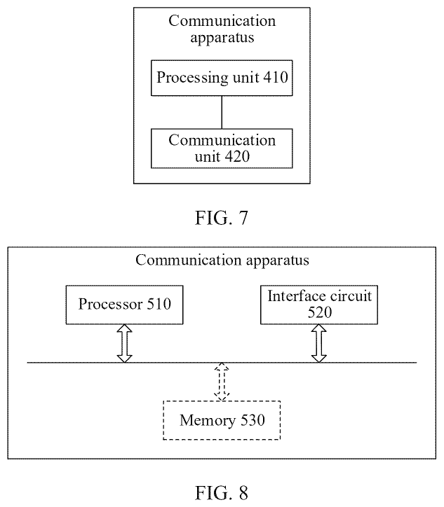

FIG. 7 and FIG. 8 are diagrams of possible structures of communication apparatuses according to embodiments of this disclosure. These communication apparatuses may be configured to implement functions of the network device or the terminal device in the foregoing method embodiments, and therefore can also implement beneficial effects of the foregoing method embodiments. In embodiments of this disclosure, the communication apparatus may be any possible terminal device having a wireless transceiver function described above, may be any possible network device that can provide wireless access for the terminal device described above, or may be a module (for example, a chip) used in the network device or the terminal device.

As shown in FIG. 7, the communication apparatus includes a processing unit 410 and a communication unit 420. The communication apparatus is configured to implement a function of the network device or the terminal device in any one of the embodiments shown in FIG. 4 to FIG. 6 and the implementations of the embodiments. For example,
when the communication apparatus is configured to implement functions of the first network device in the method embodiments shown in FIG. 4 to FIG. 6,
the communication unit 420 is configured to: receive configuration information of an uplink signal from a second network device, and send the configuration information of the uplink signal to the terminal device, where the configuration information is configuration information allocated by the second network device to a terminal device dedicated uplink signal, and an uplink measurement result of the uplink signal is used to determine whether to hand over the terminal device to a cell of the second network device; and receive the uplink measurement result from the second network device, where the uplink measurement result is obtained by the second network device through measurement based on the received uplink signal, and the uplink signal is sent by the terminal device based on the configuration information.

The processing unit 410 is configured to: determine, based on the uplink measurement result, whether to hand over the terminal device to the cell.

The communication unit 420 is configured to: if the processing unit 410 determines to hand over the terminal device to the cell, send a handover command message to the terminal device, to command the terminal device to hand over to the cell.

In an optional implementation, the communication unit 420 is further configured to receive uplink synchronization information and uplink resource allocation information from the second network device, where the uplink synchronization information is obtained by the second network device by performing uplink synchronization based on the received uplink signal, and the uplink resource allocation information indicates an uplink resource allocated by the second network device to the terminal device. The handover command message further includes the uplink synchronization information and the uplink resource allocation information.

In an optional implementation, both the uplink measurement result and a downlink measurement result reported by the terminal device include quantized bits of an amplitude and a phase of a primary eigenvector of a channel between the second network device and the terminal device, or both include an oversampling group index of a space-frequency projection matrix of a channel between the second network device and the terminal device, an index of an angle-delay pair selected after space-frequency projection, and a quantized bit of a projection result of the selected angle-delay pair.

In an optional implementation, the uplink measurement result includes a beam index of an uplink optimal beam between the second network device and the terminal device and corresponding signal strength, corresponding signal quality, or a corresponding signal-to-noise ratio.

In an optional implementation, the processing unit 410 is configured to: when an offset between signal quality of the cell and signal quality of a serving cell in the uplink measurement result is greater than a preset offset, or signal quality of a serving cell is lower than a first threshold and signal quality of the cell is higher than a second threshold, and/or when correlation between uplink and downlink measured channels obtained based on the uplink measurement result and the downlink measurement result reported by the terminal device meets a related condition, determine to hand over the terminal device to the cell. Alternatively, the processing unit 410 is configured to: when an offset between signal quality of the cell and signal quality of a serving cell in the uplink measurement result is less than or equal to a preset offset, signal quality of a serving cell is not lower than a first threshold, or signal quality of the cell is not higher than a second threshold, and/or when correlation between uplink and downlink measured channels obtained based on the uplink measurement result and the downlink measurement result reported by the terminal device does not meet a related condition, determine not to hand over the terminal device to the cell.

In an optional implementation, before receiving the configuration information of the uplink signal from the second network device, the communication unit 420 is configured to send a first request indication to the second network device, where the first request indication is used to request the second network device to allocate the configuration information of the dedicated uplink signal to the terminal device. The communication unit 420 is further configured to receive the configuration information of the uplink signal from the second network device.

In another optional implementation, before receiving the configuration information of the uplink signal from the second network device, the communication unit 420 is further configured to receive the downlink measurement result from the terminal device, where the downlink measurement result is obtained by the terminal device by performing measurement on the serving cell and a neighbor cell based on downlink measurement control information. The processing unit 410 is configured to: determine, based on the downlink measurement result, the cell to which the terminal device is allowed to be handed over and the second network device to which the cell belongs. The first network device sends a second request indication to the second network device, where the second request indication is used to request to hand over the terminal device to the cell.

In still another optional implementation, before receiving the configuration information of the uplink signal from the second network device, the communication unit 420 is further configured to receive downlink measurement feedback information from the terminal device, where the downlink measurement feedback information includes the downlink measurement result obtained by the terminal device by performing measurement on the serving cell and a neighbor cell based on the downlink measurement control information, and information about the cell selected for handover. The processing unit 410 is configured to: determine, based on the downlink measurement result, whether to allow the terminal device to be handed over to the cell. The communication unit 420 is further configured to: if the processing unit 410 determines to allow the terminal device to be handed over to the cell, send, by the first network device, a second request indication to the second network device, where the second request indication is used to request to hand over the terminal device to the cell.

In still another optional implementation, the communication unit 420 is further configured to send the first request indication and the second request indication to the second network device, to request to hand over the terminal device to the second network device and request the configuration information of the uplink signal.

When the communication apparatus is configured to implement functions of the terminal device in the method embodiments shown in FIG. 4 to FIG. 6,
the communication unit 420 is configured to receive configuration information of an uplink signal from a first network device, where the configuration information is configuration information allocated by a second network device to a terminal device dedicated uplink signal, and an uplink measurement result of the uplink signal is used by the first network device to determine whether to hand over the terminal device to a cell of the second network device. The communication unit 420 is further configured to send the uplink signal based on the configuration information.

In an optional implementation, after sending the dedicated uplink signal based on the configuration information, the communication unit 420 is further configured to: receive a handover command message from the first network device, where the handover command message indicates the terminal device to be handed over to the cell. The processing unit 410 is configured to perform cell handover based on the handover command message, and the communication unit 420 is further configured to send a handover confirm message to the second network device.

In an optional implementation, the handover command message includes uplink synchronization information and uplink resource allocation information. The uplink synchronization information is obtained by the second network device by performing uplink synchronization based on the received uplink signal, and the uplink resource allocation information indicates an uplink resource allocated by the second network device to the terminal device.

In an optional implementation, before receiving the configuration information of the uplink signal from the first network device, the communication unit 420 is configured to send a downlink measurement result to the first network device. The downlink measurement result is obtained by the terminal device by performing measurement on a serving cell and a neighbor cell based on downlink measurement control information, and is used by the first network device to determine the cell to which the terminal device is allowed to be handed over and the second network device to which the cell belongs.

In another optional implementation, before receiving the configuration information of the uplink signal from the first network device, the communication unit 420 is configured to send downlink measurement feedback information to the first network device, where the downlink measurement feedback information includes a downlink measurement result and information about the cell selected for handover. The downlink measurement result is obtained by the terminal device by performing measurement on a serving cell and a neighbor cell based on downlink measurement control information, and is used by the first network device to determine to allow the terminal device to be handed over to the cell, where a network device to which the cell belongs is the second network device.

In an optional implementation, the downlink measurement result includes quantized bits of an amplitude and a phase of a primary eigenvector of a channel between the second network device and the terminal device, or includes an oversampling group index of a space-frequency projection matrix of a channel between the second network device and the terminal device, an index of an angle-delay pair selected after space-frequency projection, and a quantized bit of a projection result of the selected angle-delay pair.

For more detailed descriptions of the processing unit 410 and the communication unit 420, refer directly to related descriptions in the method embodiments shown in FIG. 4 to FIG. 6.

When the communication apparatus is configured to implement functions of the second network device in the method embodiments shown in FIG. 4 to FIG. 6,
the communication unit 420 is configured to send configuration information of an uplink signal to a first network device, where the configuration information is configuration information allocated to a terminal device dedicated uplink signal, and an uplink measurement result of the uplink signal is used by the first network device to determine whether to hand over the terminal device to a cell of the second network device.

The processing unit 410 is configured to perform measurement based on the received uplink signal, to obtain the uplink measurement result, where the uplink signal is sent by the terminal device based on the configuration information.

The communication unit 420 is further configured to send the uplink measurement result to the first network device.

In an optional implementation, the communication unit 420 is further configured to send uplink synchronization information and uplink resource allocation information to the first network device. The uplink synchronization information is obtained by performing uplink synchronization based on the received uplink signal, and the uplink resource allocation information indicates an uplink resource allocated to the terminal device.

In an optional implementation, the uplink measurement result includes quantized bits of an amplitude and a phase of a primary eigenvector of a channel between the second network device and the terminal device, or includes an oversampling group index of a space-frequency projection matrix of a channel between the second network device and the terminal device, an index of an angle-delay pair selected after space-frequency projection, and a quantized bit of a projection result of the selected angle-delay pair; and/or the uplink measurement result includes a beam index of an uplink optimal beam between the second network device and the terminal device and corresponding signal strength, corresponding signal quality, or a corresponding signal-to-noise ratio.

In an optional implementation, before sending the configuration information of the uplink signal to the first network device, the communication unit 420 is further configured to receive a first request indication from the first network device, where the first request indication is used to request the second network device to allocate the configuration information of the dedicated uplink signal to the terminal device.

In another optional implementation, the communication unit 420 is further configured to receive a second request indication from the first network device, where the second request indication is used to request to hand over the terminal device to the cell. The processing unit 410 is configured to: if the terminal device is allowed to be handed over to the cell, trigger the communication unit 420 to perform the step of sending the configuration information of the uplink signal to the first network device.

In still another optional implementation, the communication unit 420 is further configured to receive the first request indication and the second request indication from the first network device, to request to hand over the terminal device to the second network device and request the configuration information of the uplink signal.

For more detailed descriptions of the processing unit 410 and the communication unit 420, refer directly to related descriptions in the method embodiments shown in FIG. 4 to FIG. 6.

As shown in FIG. 8, the communication apparatus includes a processor 510 and an interface circuit 520. The processor 510 and the interface circuit 520 are coupled to each other. It may be understood that the interface circuit 520 may be a transceiver or an input/output interface. Optionally, the communication apparatus may further include a memory 530, configured to: store instructions executed by the processor 510, store input data needed by the processor 510 to run instructions, or store data generated after the processor 510 runs instructions.

When the communication apparatus is configured to implement the method shown in any one of FIG. 4 to FIG. 6, the processor 510 is configured to implement functions of the processing unit 410, and the interface circuit 520 is configured to implement functions of the communication unit 420.

When the communication apparatus is a chip used in a terminal device, the chip implements functions of the terminal device in the foregoing method embodiments. The chip receives information from another module (for example, a radio frequency module or an antenna) in the terminal device, where the information is sent by a network device to the terminal device; or the chip sends information to another module (for example, a radio frequency module or an antenna) in the terminal device, where the information is sent by the terminal device to a network device.

When the communication apparatus is a module used in a network device, the module implements functions of the network device in the foregoing method embodiments. The module receives information from another module (for example, a radio frequency module or an antenna) in the network device, where the information is sent by a terminal device to the network device; or the module sends information to another module (for example, a radio frequency module or an antenna) in the network device, where the information is sent by the network device to a terminal device. The module herein may be a baseband chip of the network device, or may be a distributed unit (DU) or another module. The DU herein may be a DU in an open radio access network (O-RAN) architecture.

It may be understood that the processor in embodiments of this disclosure may be a central processing unit (CPU), or may be another general-purpose processor, a digital signal processor (DSP), an application-specific integrated circuit (ASIC), a field programmable gate array (FPGA), another programmable logic device, a transistor logic device, a hardware component, or any combination thereof. The general-purpose processor may be a microprocessor, or may be any conventional processor.

The method steps in embodiments of this disclosure may be implemented by hardware, or may be implemented by a processor executing software instructions. The software instructions may include a corresponding software module. The software module may be stored in a random access memory, a flash memory, a read-only memory, a programmable read-only memory, an erasable programmable read-only memory, an electrically erasable programmable read-only memory, a register, a hard disk, a removable hard disk, a CD-ROM, or any other form of storage medium well-known in the art. For example, a storage medium is coupled to the processor, so that the processor can read information from the storage medium, and can write information into the storage medium. Certainly, the storage medium may alternatively be a component of the processor. The processor and the storage medium may be disposed in an ASIC. In addition, the ASIC may be located in a base station or a terminal. Certainly, the processor and the storage medium may alternatively exist in a base station or a terminal as discrete components.

All or a part of the foregoing embodiments may be implemented by software, hardware, firmware, or any combination thereof. When software is used to implement embodiments, all or a part of embodiments may be implemented in a form of a computer program product. The computer program product includes one or more computer programs or instructions. When the computer program or the instructions are loaded and executed on a computer, all or some of the procedures or functions in embodiments of this disclosure are executed. The computer may be a general-purpose computer, a dedicated computer, a computer network, a network device, user equipment, or another programmable apparatus. The computer program or the instructions may be stored in a computer-readable storage medium, or may be transmitted from a computer-readable storage medium to another computer-readable storage medium. For example, the computer program or the instructions may be transmitted from a website, computer, server, or data center to another website, computer, server, or data center in a wired or wireless manner. The computer-readable storage medium may be any usable medium that can be accessed by a computer, or a data storage device, for example, a server or a data center, integrating one or more usable media. The usable medium may be a magnetic medium, for example, a floppy disk, a hard disk, or a magnetic tape; may be an optical medium, for example, a digital video disc; or may be a semiconductor medium, for example, a solid-state drive. The computer-readable storage medium may be a volatile or non-volatile storage medium, or may include two types of storage media: a volatile storage medium and a non-volatile storage medium.

In embodiments of this disclosure, unless otherwise specified or there is a logic conflict, terms and/or descriptions in different embodiments are consistent and may be mutually referenced, and technical features in different embodiments may be combined based on an internal logical relationship thereof, to form a new embodiment.

It may be understood that various numbers in embodiments of this disclosure are merely used for differentiation for ease of description, and are not used to limit the scope of embodiments of this disclosure. Sequence numbers of the foregoing processes do not mean execution sequences. The execution sequences of the processes should be determined based on functions and internal logic of the processes.

1. A cell handover method, wherein the method comprises:
receiving configuration information of an uplink signal from a network device, wherein the uplink signal is allocated by the network device and dedicated to a terminal;
sending the configuration information of the uplink signal to the terminal;
receiving an uplink measurement result from the network device, wherein the uplink measurement result is obtained by the network device through measurement based on the received uplink signal, and the uplink signal is sent by the terminal based on the configuration information; and
determining, based on the uplink measurement result, whether to hand over the terminal to a cell of the network device.

2. The method according to claim 1, further comprising:
sending a handover command message to the terminal in response to determining that the terminal is to be handed over to the cell, wherein the handover command message indicates the terminal to be handed over to the cell.

3. The method according to claim 2, further comprising:
receiving uplink synchronization information and uplink resource allocation information from the network device, wherein the uplink synchronization information is obtained by the network device by performing uplink synchronization based on the received uplink signal, and the uplink resource allocation information indicates an uplink resource allocated by the network device to the terminal.

4. The method according to claim 3, wherein the handover command message further comprises the uplink synchronization information and the uplink resource allocation information.

5. The method according to claim 4, wherein determining, based on the uplink measurement result, whether to hand over the terminal to the cell comprises:
determining to hand over the terminal to the cell when at least one of:
an offset between signal quality of the cell and signal quality of a serving cell in the uplink measurement result is greater than a preset offset;
the signal quality of the serving cell is lower than a first threshold and the signal quality of the cell is higher than a second threshold; or
correlation between uplink and downlink measured channels obtained based on the uplink measurement result and a downlink measurement result reported by the terminal meets a related condition; or
determining not to hand over the terminal to the cell when at least one of:
an offset between signal quality of the cell and signal quality of a serving cell in the uplink measurement result is less than or equal to a preset offset;
the signal quality of the serving cell is not lower than a first threshold, the signal quality of the cell is not higher than a second threshold; or
correlation between uplink and downlink measured channels obtained based on the uplink measurement result and a downlink measurement result reported by the terminal does not meet a related condition, determining not to hand over the terminal to the cell.

6. The method according to claim 1, wherein the uplink measurement result comprises quantized bits of an amplitude and a phase of a primary eigenvector of a channel between the network device and the terminal.

7. The method according to claim 1, wherein the uplink measurement result comprises an oversampling group index of a space-frequency projection matrix of a channel between the network device and the terminal, an index of an angle-delay pair selected after space-frequency projection, and a quantized bit of a projection result of the selected angle-delay pair.

8. The method according to claim 1, wherein the uplink measurement result comprises a beam index of an uplink optimal beam between the network device and the terminal and at least one of corresponding signal strength, corresponding signal quality, or a corresponding signal-to-noise ratio.

9. The method according to claim 1, further comprising:
sending a first request indication to the network device, wherein the first request indication is used to request the network device to allocate the uplink signal dedicated to the terminal.

10. The method according to claim 1, further comprising:
receiving a downlink measurement result from the terminal, wherein the downlink measurement result is obtained by the terminal by performing measurement on a serving cell and a neighbor cell based on downlink measurement control information;
determining, based on the downlink measurement result, the cell to which the terminal is allowed to be handed over and the network device to which the cell belongs; and
sending a second request indication to the network device, wherein the second request indication is used to request to hand over the terminal to the cell.

11. The method according to claim 1, further comprising:
receiving downlink measurement feedback information from the terminal, wherein the downlink measurement feedback information comprises a downlink measurement result obtained by the terminal by performing measurement on a serving cell and a neighbor cell based on a downlink measurement control information, and information about the cell selected for handover;
determining, based on the downlink measurement result, whether to allow the terminal to be handed over to the cell; and
sending a second request indication to the network device in response to determining that the terminal is allowed to be handed over to the cell, wherein the second request indication is used to request to hand over the terminal to the cell.

12. A method, wherein the method is applicable to a terminal and comprises:
receiving configuration information of an uplink signal from a first network device, wherein the uplink signal is allocated by a second network device and dedicated to the terminal, and an uplink measurement result of the uplink signal is used by the first network device to determine whether to hand over the terminal to a cell of the second network device; and
sending the uplink signal based on the configuration information.

13. The method according to claim 12, further comprising:
receiving a handover command message from the first network device, wherein the handover command message indicates the terminal to be handed over to the cell;
performing cell handover based on the handover command message; and
sending a handover confirm message to the second network device.

14. The method according to claim 13, wherein the handover command message comprises uplink synchronization information and uplink resource allocation information.

15. The method according to claim 14, wherein the uplink synchronization information is obtained by the second network device by performing uplink synchronization based on the received uplink signal, and the uplink resource allocation information indicates an uplink resource allocated by the second network device to the terminal.

16. The method according to claim 12, further comprising:
sending a downlink measurement result to the first network device, wherein the downlink measurement result is obtained by the terminal by performing measurement on a serving cell and a neighbor cell based on downlink measurement control information.

17. The method according to claim 16, wherein the downlink measurement result comprises quantized bits of an amplitude and a phase of a primary eigenvector of a channel between the second network device and the terminal.

18. The method according to claim 16, wherein the downlink measurement result comprises an oversampling group index of a space-frequency projection matrix of a channel between the second network device and the terminal, an index of an angle-delay pair selected after space-frequency projection, and a quantized bit of a projection result of the selected angle-delay pair.

19. The method according to claim 12, further comprising:
sending downlink measurement feedback information to the first network device, wherein the downlink measurement feedback information comprises a downlink measurement result and information about the cell selected for handover, wherein the downlink measurement result is obtained by the terminal by performing measurement on a serving cell and a neighbor cell based on downlink measurement control information, and is used by the first network device to determine to allow the terminal to be handed over to the cell, and wherein a network device to which the cell belongs is the second network device.

20. A method, wherein the method is applicable to a second network device and comprises:
sending configuration information of an uplink signal to a first network device, wherein the uplink signal is allocated and dedicated to a terminal, and an uplink measurement result of the uplink signal is used by the first network device to determine whether to hand over the terminal to a cell of a second network device;
performing measurement based on the received uplink signal to obtain the uplink measurement result, wherein the uplink signal is sent by the terminal based on the configuration information; and
sending the uplink measurement result to the first network device.
